(19) United States
(12) Patent Application Publication
(10) Pub. No.: US 2024/0357343 A1
(43) Pub. Date: Oct. 24, 2024

(54) WLAN BASED RF SENSING IN CELLULAR SYSTEMS

(71) Applicant: QUALCOMM Incorporated, San Diego, CA (US)

(72) Inventors: Marwen ZORGUI, San Diego, CA (US); Xiaoxia ZHANG, San Diego, CA (US); Rajat PRAKASH, San Diego, CA (US); Srinivas YERRAMALLI, San Diego, CA (US)

(21) Appl. No.: 18/306,148

(22) Filed: Apr. 24, 2023

(51) Int. Cl. H04W 8/22; H04W 8/00; H04W 24/10

(52) U.S. Cl. CPC H04W 8/22; H04W 8/005; H04W 24/10; H04W 84/12

(57) ABSTRACT

Various technologies pertaining to wireless communication at a UE are disclosed herein. The UE transmits capability information for WLAN RF based sensing for the wireless device. The UE obtains, based on the capability information, at least one of a configuration or assistance data for the WLAN RF based sensing for the wireless device, where at least one of the configuration or the assistance data indicates at least one of a set of RF sensing measurements for the WLAN RF based sensing or a set of RF sensing parameters for the WLAN RF based sensing.

### TECHNICAL FIELD

The present disclosure relates generally to communication systems, and more particularly, to wireless local area network (WLAN) based sensing.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus for wireless communication at a network entity are provided. The apparatus includes a memory; and at least one processor coupled to the memory and, based at least in part on information stored in the memory, the at least one processor is configured to: obtain capability information for wireless local area network (WLAN) radio frequency (RF) based sensing for at least one wireless device; and transmit, for the at least one wireless device and based on the capability information, at least one of a configuration or assistance data for the WLAN RF based sensing, where at least one of the configuration or the assistance data indicates at least one of a set of RF sensing measurements for the WLAN RF based sensing or a set of RF sensing parameters for the WLAN RF based sensing.

In an aspect of the disclosure, a method, a computer-readable medium, and an apparatus for wireless communication at a wireless device are provided. The apparatus includes a memory; and at least one processor coupled to the memory and, based at least in part on information stored in the memory, the at least one processor is configured to: transmit capability information for wireless local area network (WLAN) radio frequency (RF) based sensing for the wireless device; and obtain, based on the capability information, at least one of a configuration or assistance data for the WLAN RF based sensing for the wireless device, where at least one of the configuration or the assistance data indicates at least one of a set of RF sensing measurements for the WLAN RF based sensing or a set of RF sensing parameters for the WLAN RF based sensing.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of a wireless communication system.

FIG. 6 is a diagram illustrating an example positioning procedure.

FIG. 7 is a diagram illustrating example aspects of positioning techniques.

FIG. 8 is a diagram illustrating example aspects of wireless local area network (WLAN) based positioning.

FIG. 9 is a diagram illustrating example aspects of WLAN based positioning.

FIG. 10 is a diagram illustrating example aspects of WLAN based positioning.

FIG. 11 is a diagram illustrating example aspects of sensing feedback for WLAN based positioning.

FIG. 12 is a diagram illustrating an example of a wireless device sharing WLAN radio frequency (RF) sensing capabilities with a sensing entity of a core network.

FIG. 13 is a diagram illustrating example aspects of configuring a UE for WLAN based RF sensing.

FIG. 14 is a diagram illustrating example aspects of configuring an access point (AP) for WLAN based RF sensing.

FIG. 15 is a diagram illustrating example aspects of assistance data for WLAN based RF sensing.

FIG. 16 is a diagram illustrating example communications between a network entity and a wireless device.

FIG. 17 is a flowchart of a method of wireless communication.

FIG. 18 is a flowchart of a method of wireless communication.

FIG. 19 is a diagram illustrating an example of a hardware implementation for an example apparatus.

FIG. 20 is a diagram illustrating an example of a hardware implementation for an example network entity.

FIG. 21 is a diagram illustrating an example of a hardware implementation for an example network entity.

### DETAILED DESCRIPTION

A cellular communication system may utilize different techniques for positioning in order to ascertain a location of a UE or another object. WLAN communication systems may utilize WLAN RF sensing for positioning purposes. However, the inter-play between positioning in cellular communication systems and WLAN communication systems may not be well-defined with respect to particular features in WLAN RF sensing, thus leading to technical challenges. For instance, a cellular communication system may not be configured to facilitate positioning without the involvement of a UE.

Various aspects relate generally to sensing. Some aspects more specifically relate to WLAN based sensing. In an example, a network entity obtains capability information for wireless local area network (WLAN) radio frequency (RF) based sensing for at least one wireless device. The network entity transmits, for the at least one wireless device and based on the capability information, at least one of a configuration or assistance data for the WLAN RF based sensing, where at least one of the configuration or the assistance data indicates at least one of a set of RF sensing measurements for the WLAN RF based sensing or a set of RF sensing parameters for the WLAN RF based sensing.

Particular aspects of the subject matter described in this disclosure can be implemented to realize one or more of the following potential advantages. In some examples, by transmitting at least one of the configuration or the assistance data for the WLAN RF based sensing, the network entity may enable the at least one wireless device to perform enhanced positioning techniques using WLAN RF based sensing. For instance, the configuration and/or the assistance data may enable the at least one wireless device to ascertain a location of the wireless device or another object in a more accurate manner compared to wireless devices that do not receive the configuration (which is based on the capability information) or the assistance data for the WLAN RF based sensing. In another example, the transmitted configuration and/or assistance data may enable positioning to be performed via an AP without involving a UE. Furthermore, the transmitted configuration may enable the AP to transmit a sensing result to the network entity without assistance from a UE.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

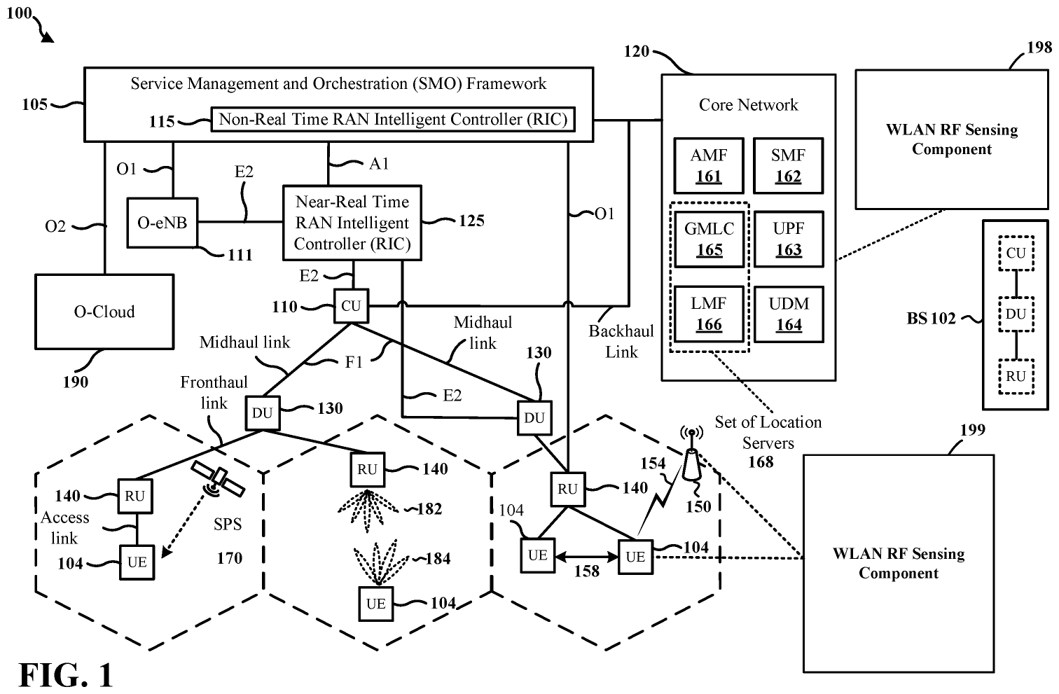

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHZ (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi™ AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR2-2 (52.6 GHZ-71 GHz), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band. The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the core network 120 may have a WLAN RF sensing component 198 that may be configured to obtain capability information for WLAN RF based sensing for at least one wireless device; and transmit, for the at least one wireless device and based on the capability information, at least one of a configuration or assistance data for the WLAN RF based sensing, where at least one of the configuration or the assistance data indicates at least one of a set of RF sensing measurements for the WLAN RF based sensing or a set of RF sensing parameters for the WLAN RF based sensing. In certain aspects, the UE 104 and/or the Wi-Fi™ AP 150 may have a WLAN RF sensing component 199 that may be configured to transmit capability information for wireless local area network WLAN RF based sensing for the wireless device; and obtain, based on the capability information, at least one of a configuration or assistance data for the WLAN RF based sensing for the wireless device, where at least one of the configuration or the assistance data indicates at least one of a set of RF sensing measurements for the WLAN RF based sensing or a set of RF sensing parameters for the WLAN RF based sensing. Although the following description may be focused on 5G NR, the concepts described herein may also be applicable to other types of wireless communication systems as well.

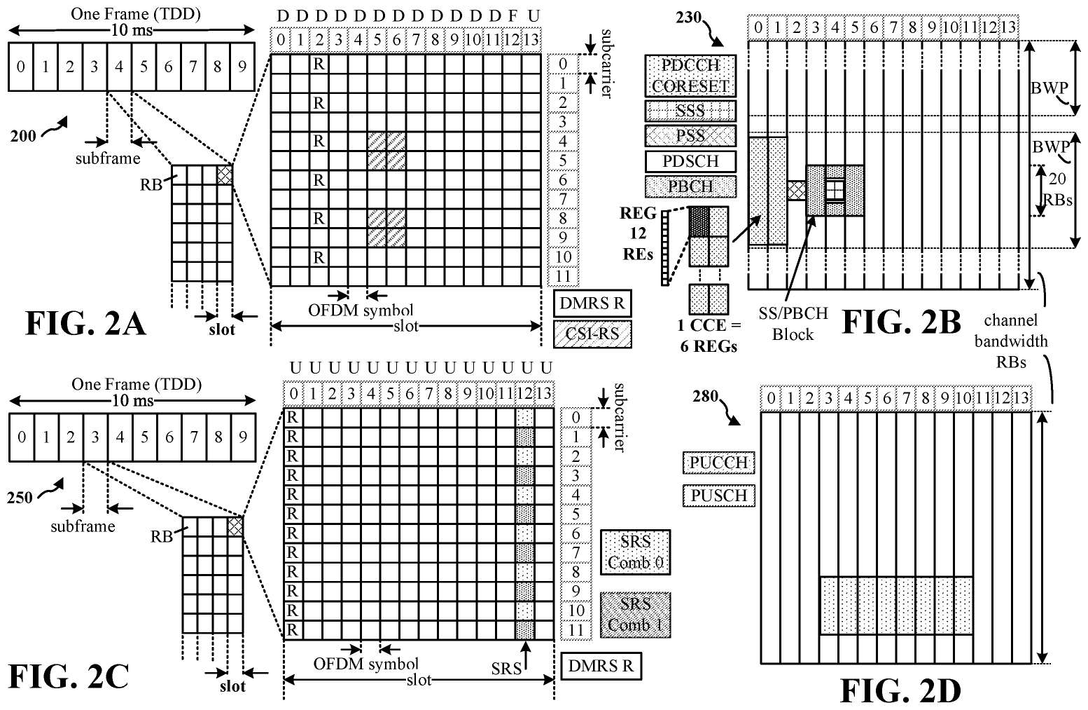

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

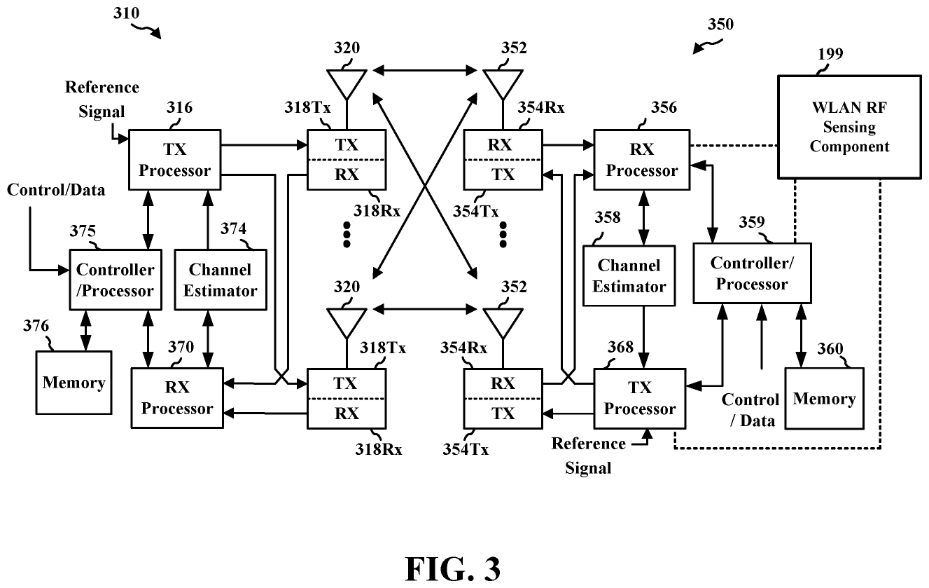

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the WLAN RF sensing component 199 of FIG. 1.

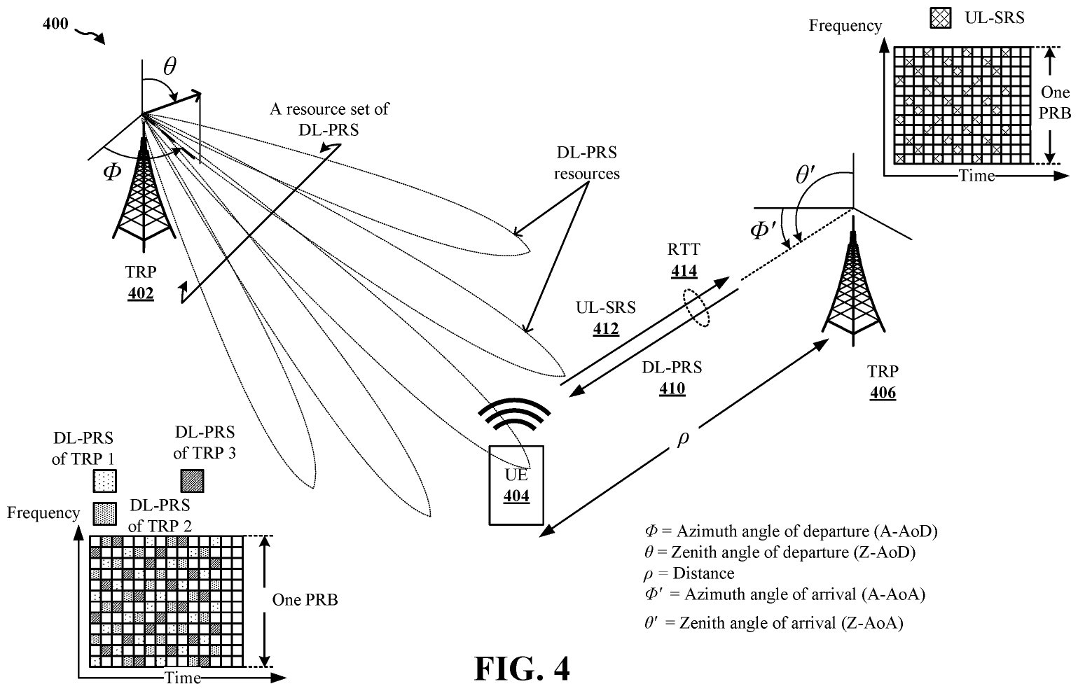

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

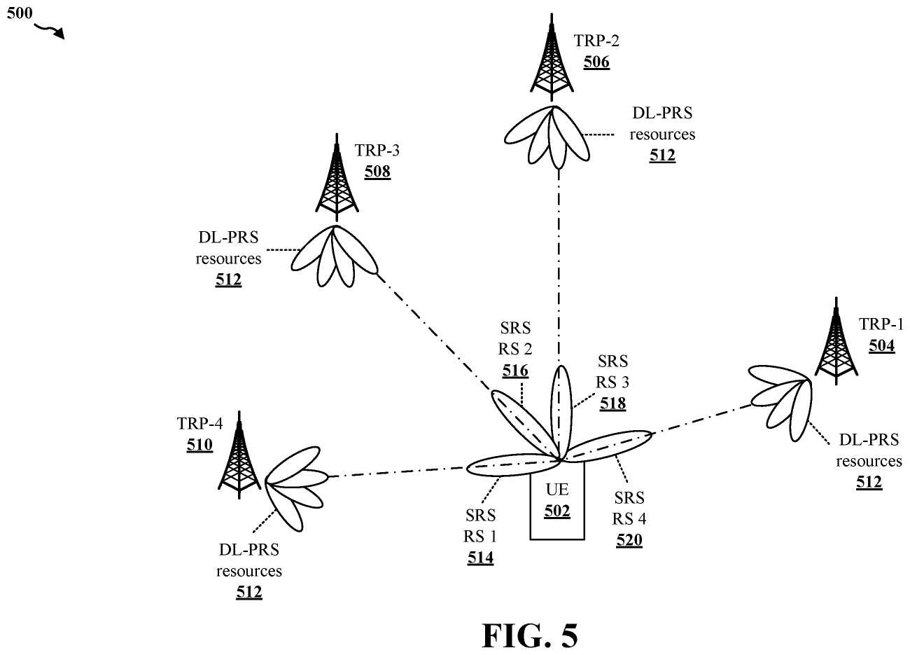

FIG. 5 is a diagram 500 illustrating an example of estimating a position of a UE based on multi-RTT measurements from multiple TRPs in accordance with various aspects of the present disclosure. A UE 502 may be configured by a serving base station to decode DL-PRS resources 512 that correspond to and are transmitted from a first TRP 504 (TRP-1), a second TRP 506 (TRP-2), a third TRP 508 (TRP-3), and a fourth TRP 510 (TRP-4). The UE 502 may also be configured to transmit UL-SRSs on a set of UL-SRS resources, which may include a first SRS resource 514, a second SRS resource 516, a third SRS resource 518, and a fourth SRS resource 520, such that the serving cell(s), e.g., the first TRP 504, the second TRP 506, the third TRP 508, and the fourth TRP 510, and as well as other neighbor cell(s), may be able to measure the set of the UL-SRS resources transmitted from the UE 502. For multi-RTT measurements based on DL-PRS and UL-SRS, as there may be an association between a measurement of a UE for the DL-PRS and a measurement of a TRP for the UL-SRS, the smaller the gap is between the DL-PRS measurement of the UE and the UL-SRS transmission of the UE, the better the accuracy may be for estimating the position of the UE and/or the distance of the UE with respect to each TRP.

In some aspects of wireless communication, the terms “positioning reference signal” and “PRS” may generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. In some aspects, a downlink positioning reference signal may be referred to as a “DL-PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

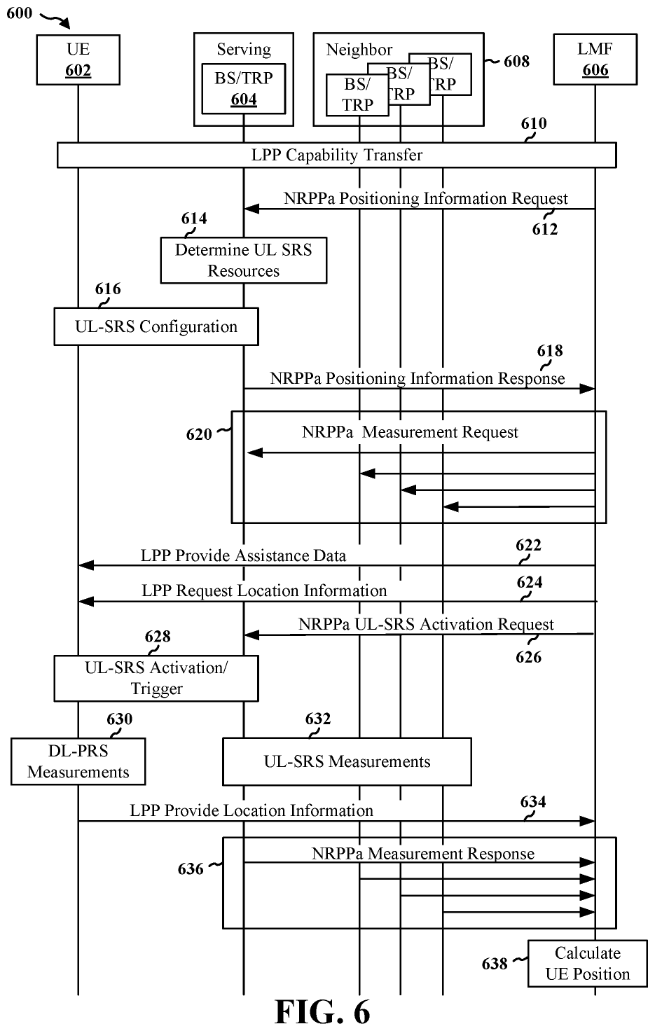

FIG. 6 is a communication flow 600 illustrating an example multi-RTT positioning procedure in accordance with various aspects of the present disclosure. The numberings associated with the communication flow 600 do not specify a particular temporal order and are merely used as references for the communication flow 600. In addition, a DL-only and/or an UL-only positioning may use a subset or subsets of this multi-RTT positioning procedure.

At 610, an LMF 606 may request one or more positioning capabilities from a UE 602 (e.g., from a target device). In some examples, the request for the one or more positioning capabilities from the UE 602 may be associated with an LTE Positioning Protocol (LPP). For example, the LMF 606 may request the positioning capabilities of the UE 602 using an LPP capability transfer procedure. At 612, the LMF 606 may request UL SRS configuration information for the UE 602. The LMF 606 may also provide assistance data specified by a serving base station 604 (e.g., pathloss reference, spatial relation, and/or SSB configuration(s), etc.). For example, the LMF 606 may send an NR Positioning Protocol A (NRPPa) positioning information request message to the serving base station 604 to request UL information for the UE 602.

At 614, the serving base station 604 may determine resources available for UL SRS, and at 616, the serving base station 604 may configure the UE 602 with one or more UL SRS resource sets based on the available resources. At 618, the serving base station 604 may provide UL SRS configuration information to the LMF 606, such as via an NRPPa positioning information response message. At 620, the LMF 606 may select one or more candidate neighbor BSs/TRPs 608, and the LMF 606 may provide an UL SRS configuration to the one or more candidate neighbor BSs/TRPs 608 and/or the serving base station 604, such as via an NRPPa measurement request message. The message may include information for enabling the one or more candidate neighbor BSs/TRPs 608 and/or the serving base station to perform the UL measurements.

At 622, the LMF 606 may send an LPP provide assistance data message to the UE 602. The message may include specified assistance data for the UE 602 to perform the DL measurements. At 624, the LMF 606 may send an LPP request location information message to the UE 602 to request multi-RTT measurements. At 626, for semi-persistent or aperiodic UL SRS, the LMF 606 may request the serving base station 604 to activate/trigger the UL SRS in the UE 602. For example, the LMF 606 may request activation of UE SRS transmission by sending an NRPPa positioning activation request message to the serving base station 604.

At 628, the serving base station 604 may activate the UE SRS transmission and send an NRPPa positioning activation response message. In response, the UE 602 may begin the UL-SRS transmission according to the time domain behavior of UL SRS resource configuration. At 630, the UE 602 may perform the DL measurements from the one or more candidate neighbor BSs/TRPs 608 and/or the serving base station 604 provided in the assistance data. At 632, each of the configured one or more candidate neighbor BSs/TRPs 608 and/or the serving base station 604 may perform the UL measurements. At 634, the UE 602 may report the DL measurements to the LMF 606, such as via an LPP provide location information message. At 636, each of the one or more candidate neighbor BSs/TRPs 608 and/or the serving base station 604 may report the UL measurements to the LMF 606, such as via an NRPPa measurement response message. At 638, the LMF 606 may determine the RTTs from the UE 602 and BS/TRP Rx-Tx time difference measurements for each of the one or more candidate neighbor BSs/TRPs 608 and/or the serving base station 604 for which corresponding UL and DL measurements were provided at 634 and 636, and the LMF 606 may calculate the position of the UE 602.

Some aspects of wireless communication may utilize different types of positioning reference signals (PRSs), such as downlink (DL) PRSs. PRSs are utilized by different wireless communications (e.g., new radio (NR)) and positioning methods in order to enable devices (e.g., UEs) to detect and measure different objects. For example, PRSs may enable UEs to detect and measure an increased about of neighbor TRPs or base stations. Several different types of positioning configurations are supported in wireless communications in order to enable a variety of deployments or environments for the devices or UEs (e.g., indoor environments, outdoor environments, sub-6 environments, mmW environments). Both UE-assisted positioning methods (e.g., calculations) and UE-based position methods are supported by different types of wireless communications (e.g., NR). Further, some types of positioning methods may be supported by specific types of wireless communication (e.g., NR). For instance, NR positioning methods may support at least one of: NR multiple round trip time (multi-RTT) positioning, NR downlink (DL) time difference of arrival (DL-TDOA) positioning, or NR DL angle of departure (DL-AoD) positioning.

In some aspects, different types of reference signals (e.g., downlink (DL) or uplink (UL) reference signals) and UE measurements may be utilized to facilitate the support of different positioning techniques. For example, DL PRSs and DL reference signal time difference (RSTD) UE measurements may facilitate support of DL-TDOA positioning. Also, DL PRSs and DL PRS reference signal received power (RSRP) UE measurements may facilitate support of DL-TDOA positioning. DL-AoD positioning, and/or multi-RTT positioning. Moreover, DL PRSs and sounding reference signals (SRS) for positioning and UE reception (Rx)-transmission (Tx) time different UE measurements may facilitate support of multi-RTT positioning. Further, synchronization signal blocks (SSBs) and channel state information (CSI)-reference signals (CSI-RSs) for radio resource management (RRM), as well as synchronization signal (SS)-RSRP (e.g., RSRP for RRM), SS-reference signal received quality (SS-RSRQ) (e.g., for RRM), CSI-RSRP (e.g., for RRM), and CSI-RSRP (e.g., for RRM), may facilitate support of enhanced-cell identifier (ID) (E-CID) positioning.

Different aspects of positioning may also utilize preconfigured DL PRS assistance data (AD). Preconfigured DL PRS AD may refer to the DL-PRS assistance data (with associated validity criteria) that may be provided to the UE (e.g., before or during an ongoing LTE positioning protocol (LPP) positioning session), to be then utilized for potential positioning measurements at a subsequent time (e.g., for deferred mobile terminated location request (MT-LR)). In some aspects, pre-configured DL-PRS assistance data may include multiple instances, where each instance may be applicable to a different area within the network. Also, each DL-PRS assistance data instance may be associated with an area ID. In some instances, the area ID may include a list of cells where the UE may be camped on/connected. Further, an applicable area ID at the UE location may be selected based on the cell where the UE is camped on/connected. The instance of the assistance data may be valid/selected if the UE is camped on/connected to one of the cells indicated within the list of cells in the area ID.

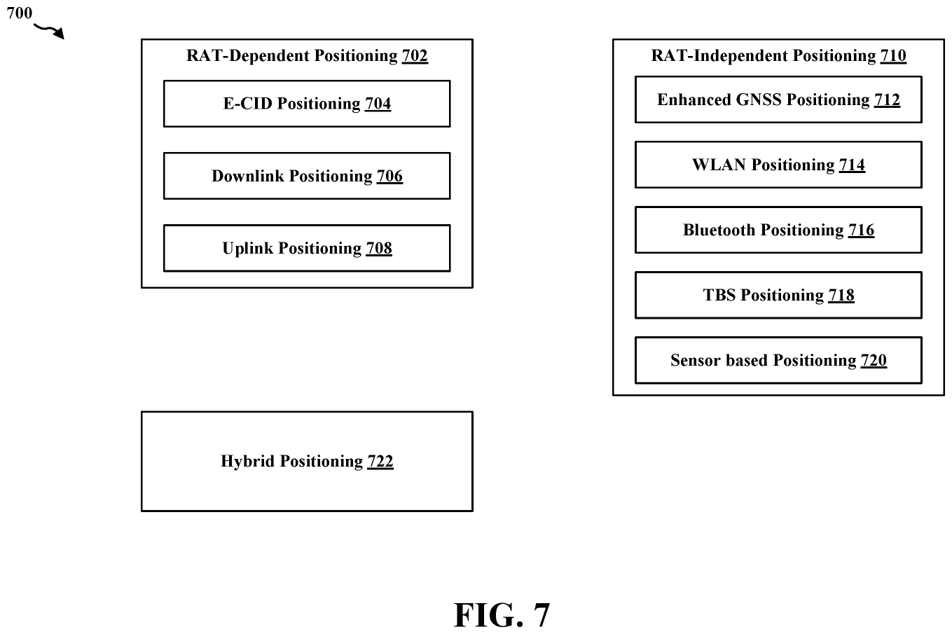

FIG. 7 is a diagram 700 illustrating example aspects of positioning techniques. Some cellular systems (i.e., wireless communication systems, such as a 5G NR wireless communication system) may support techniques (i.e., 5G NR positioning techniques) that enable wireless devices to perform positioning. Positioning may refer to determining a location (i.e., a position) of a wireless device or another object based on signals/data exchanged between the wireless device and another wireless device, measurements performed on the signals/data, and/or other types of measurements.

Positioning may include radio access technology (RAT) dependent positioning 702. In RAT-dependent positioning 702, a location of a wireless device is determined based upon measurements performed on data/signals transmitted via a radio access network (RAN), such as 5G NR RAN. RAT-dependent positioning 702 may include enhanced cell ID (c-CID) positioning 704. In e-CID positioning 704, a position of a UE may be calculated based on at least one of a serving cell ID, a timing advance, an estimated timing and power of detected neighbor cells of the UE, and/or other information such as an angle of arrival. In an example, e-CID positioning 704 may utilize received signal strength (RSS) measurements, RTT measurements, and/or angle of arrival measurements in order to calculate a position of the UE. RAT-dependent positioning 702 may include downlink positioning 706. In downlink positioning 706, a position of a UE may be calculated based on observed time difference of arrival (OTDOA) measurements. RAT-dependent positioning 702 may include uplink positioning 708. In uplink positioning 708, a position of a UE may be calculated based on uplink time difference of arrival (UTDOA) measurements.

Positioning may include RAT-independent positioning 710. In RAT-independent positioning 710, a location of a wireless device is determined based upon measurements performed on data/signals transmitted wirelessly and/or other measurements. RAT-independent positioning 710 may not depend on an existence of a RAN, such as a 5G NR RAN. RAT-independent positioning 710 may include enhanced GNSS positioning 712, WLAN positioning 714, Bluetooth positioning 716, terrestrial beacon system (TBS) positioning 718, and sensor based positioning 720. WLAN positioning 714 may refer to positioning performed via a wireless communication network that is based on an 802.11 protocol. For instance, WLAN positioning 714 may make use of WLAN measurements (AP identifiers and optionally other measurements) and databases to determine a location of a UE. The UE may measure received signals from WLAN access points (APs), optionally aided by assistance data, to send measurements to a positioning server for position calculation. Using the measurement results and a references database, the location of the UE may be calculated. Alternatively, the UE may make use of WLAN measurements and WLAN AP assistance data provided by a positioning server to determine a location of the UE. In an example, WLAN positioning 714 may include performing RTT measurements, received signal strength indicator (RSSI) measurements, and/or angle measurements. WLAN positioning 714 may also be referred to as WLAN RF based positioning or WLAN based positioning. Sensor based positioning 720 may refer to positioning performed based on sensors in a UE, such as a barometric sensor, a motion sensor, etc.

Positioning may include hybrid positioning 722. Hybrid positioning 722 may incorporate one or more aspects of RAT-dependent positioning 702 and/or one or more aspects of RAT-independent positioning 710 as described above. In an example, hybrid positioning 722 may include assisted GNSS (A-GNSS) positioning combined with OTDOA positioning.

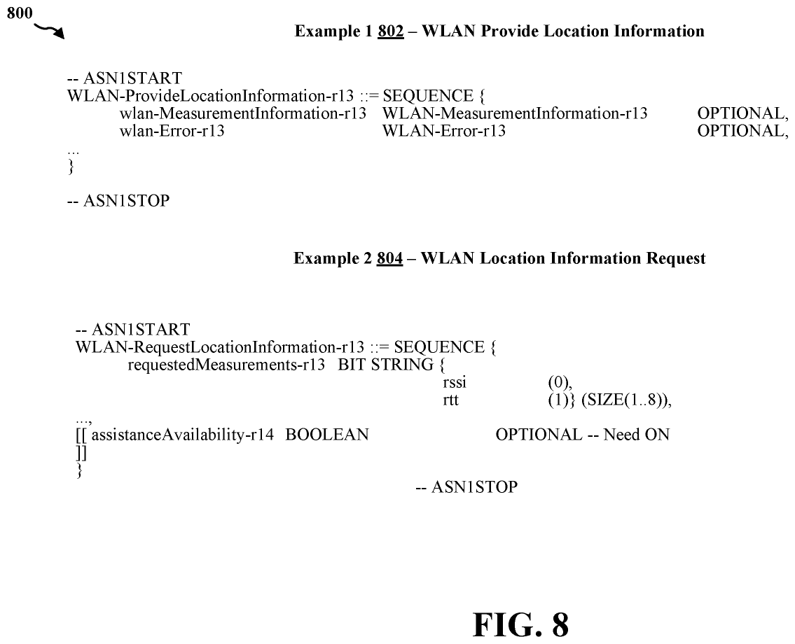

FIG. 8 is a diagram 800 illustrating example aspects of WLAN based positioning. The example aspects may correspond to the WLAN positioning 714 described above. In a first example 802, a “WLAN-ProvideLocationInformation” information element (IE) may be used by a target device to provide measurements for one or more WLANs to a location server. The “WLAN-ProvideLocationInformation” IE may also be used to provide a WLAN positioning specific error reason. The first example 802 shows data that may be included in the “WLAN-ProvideLocationInformation” IE.

In a second example 804, a “WLAN-RequestLocationInformation” IE may be used by a location server to request WLAN measurements from a target device. The second example 804 shows data that may be included in the “WLAN-RequestLocationInformation” IE.

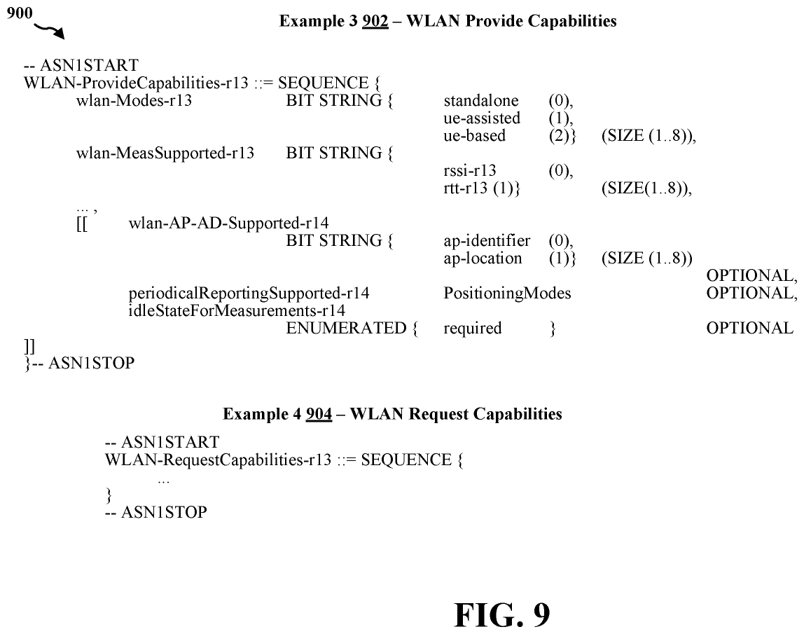

FIG. 9 is a diagram 900 illustrating example aspects of WLAN based positioning. The example aspects may correspond to the WLAN positioning 714 described above. In a third example 902, a “WLAN-ProvideCapabilities” IE may be used by a target device to provide capabilities of the target device for WLAN positioning to a location server. The third example 902 shows data that may be included in the “WLAN-ProvideCapabilities” IE.

In a fourth example 904, a “WLAN-RequestCapabilities” IE may be used by a location server to request WLAN positioning capability information from a target device. The fourth example 904 shows data that may be included in the “WLAN-RequestCapabilities” IE.

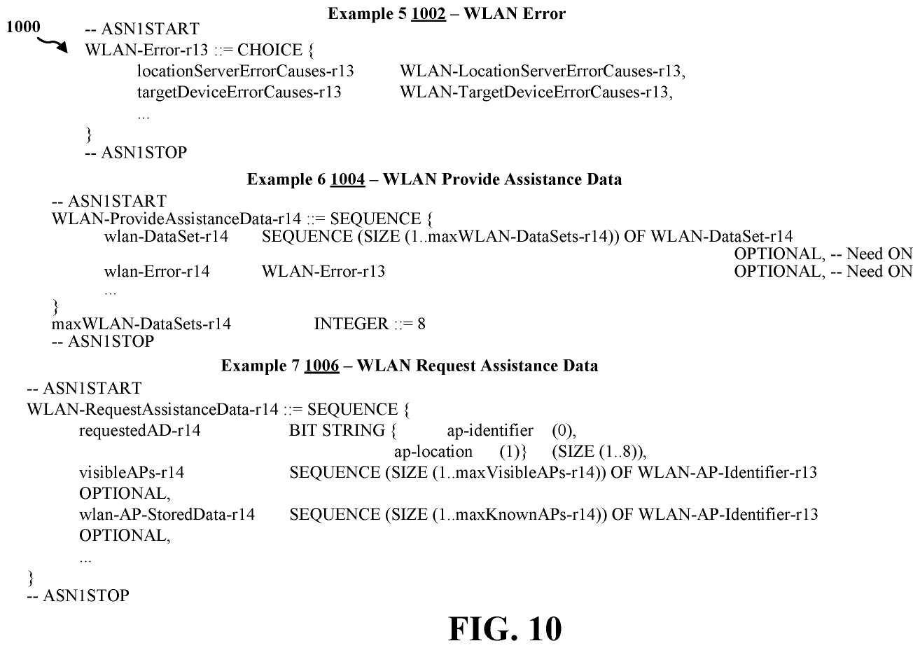

FIG. 10 is a diagram 1000 illustrating example aspects of WLAN based positioning. The example aspects may correspond to the WLAN positioning 714 described above. In a fifth example 1002, a “WLAN-Error” IE may be used by a location server or a target device to provide error reasons for WLAN positioning to the target device or the location server, respectively. The fifth example 1002 shows data that may be included in the “WLAN-Error” IE.

In a sixth example 1004, a “WLAN-ProvideAssistanceData” IE may be used by a location server to provide assistance data to enable UE-based and UE-assisted WLAN positioning. The “WLAN-ProvideAssistanceData” IE may also be used to provide a WLAN positioning specific error reason. The sixth example 1004 shows data that may be included in the “WLAN-ProvideAssistanceData” IE.

In a seventh example 1006, a “WLAN-RequestAssistanceData” IE may be used by a target device to request WLAN assistance data from a location server. The seventh example 1006 shows data that may be included in the “WLAN-RequestAssistanceData” IE.

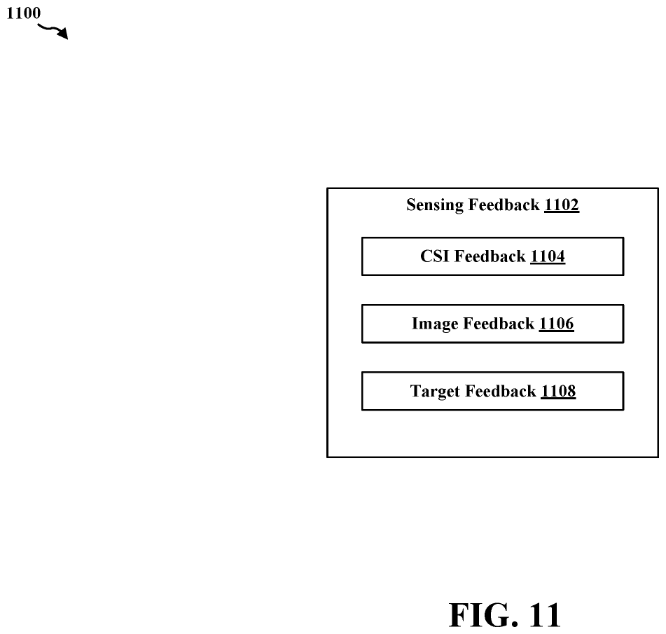

FIG. 11 is a diagram 1100 illustrating example aspects of sensing feedback 1102 for WLAN based positioning. Sensing feedback 1102 (which may also be referred to as “feedback”) may refer to a type of measurement supported for WLAN based RF sensing. The sensing feedback 1102 may correspond to (i.e., be supported by) a IEEE 802.11bf protocol.

Sensing feedback 1102 may include channel state information (CSI) feedback 1104. In CSI feedback 1104, a channel impulse response (time domain) may be returned for a combination of reception (Rx) and/or transmission (Tx). In CSI feedback 1104, sensing/radar processing may be performed at an initiating device (as opposed to a responding device). CSI feedback 1104 may enable non-radar type sensing (e.g., sensing performed based on data/signals transmitted at a frequency of less than 7 GHz).

Sensing feedback 1102 may include image feedback 1106. Image feedback 1106 may include two-dimensional (2D), three-dimensional (3D) images, and/or four-dimensional (4D) images, including one or more of range measurements, azimuth measurements, elevation measurements, and/or Doppler measurements. In image feedback 1106, a responding device may perform filtering (e.g., constant false alarm rate (CFAR) filtering) to remove non-real reflections from images, that is, the responding device may cause real reflections to be included as part of feedback and not non-real reflections.

Sensing feedback 1102 may include target feedback 1108. In target feedback 1108, a target may be an object and the object may present several reflections. In target feedback 1108, feedback for each target may include a range measurement, an azimuth measurement, an elevation measurement, and/or a Doppler measurement, as well as corresponding ranges for each of the range measurement, the azimuth measurement, the elevation measurement, and/or the Doppler measurement. A responding device may integrate the range measurement, the azimuth measurement, the elevation measurement, and/or the Doppler measurement (which may collectively be referred to as range/azimuth/elevation/Doppler points) into targets.

A cellular communication system may utilize different techniques for positioning in order to ascertain a location of a UE or another object. WLAN communication systems may utilize WLAN RF sensing for positioning purposes. However, the inter-play between positioning in cellular communication systems and WLAN communication systems may not be well-defined with respect to particular features in WLAN RF sensing, thus leading to technical challenges. For instance, a cellular communication system may not be configured to facilitate positioning without the involvement of a UE.

Various technologies pertaining to WLAN-based RF sensing in cellular systems are described herein. In an example, a network entity obtains capability information for WLAN RF-based sensing for at least one wireless device. The network entity transmits, for the at least one wireless device and based on the capability information, at least one of a configuration or assistance data for the WLAN RF-based sensing, where at least one of the configuration or the assistance data indicates at least one of a set of RF sensing measurements for the WLAN RF-based sensing or a set of RF sensing parameters for the WLAN RF-based sensing. Vis-à-vis transmitting at least one of the configuration or the assistance data for the WLAN RF-based sensing, the network entity may enable the at least one wireless device to perform enhanced positioning techniques. For instance, the configuration and/or the assistance data may enable the at least one wireless device to ascertain a location of the wireless device or another object in a more accurate manner compared to wireless devices that do not receive the configuration (which is based on the capability information) or the assistance data for the WLAN RF-based sensing.

WLAN-based RF sensing can utilize Wi-Fi™ for RF sensing. NR procedures for supporting WLAN-based RF sensing are described herein. In an example, a UE or an AP may provide their respective capabilities for WLAN RF sensing to a sensing entity. In an example, the capabilities may include type(s) of measurements the UE/AP supports in WLAN-based RF sensing. Furthermore, the sensing entity may configure the UE with WLAN-based RF sensing.

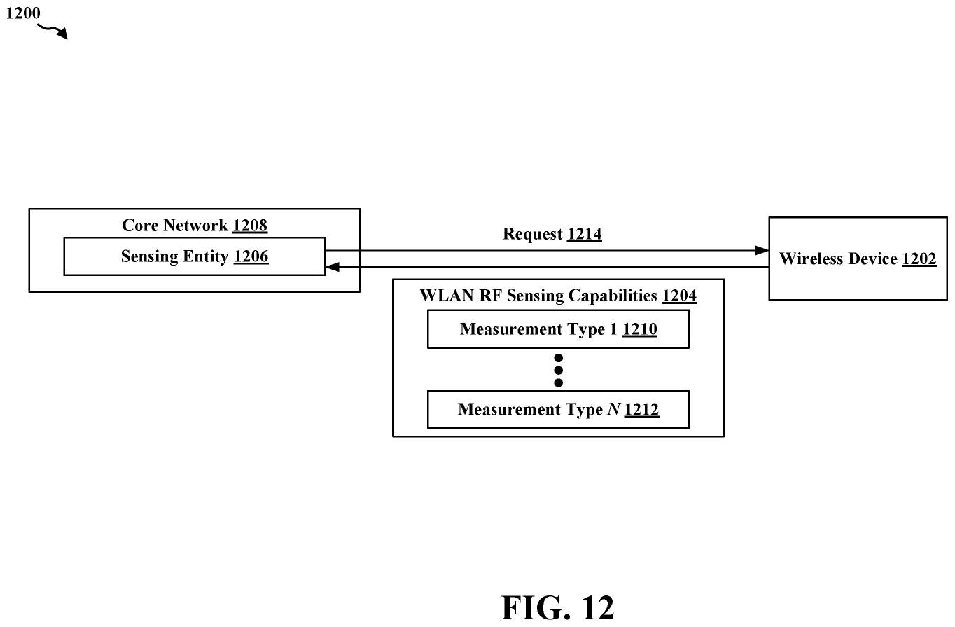

FIG. 12 is a diagram 1200 illustrating an example of a wireless device 1202 sharing WLAN RF sensing capabilities 1204 with a sensing entity 1206 of a core network 1208. In an example, the core network 1208 may be the core network 120. In an example, the wireless device 1202 may be a UE or an access point (e.g., a WLAN AP).

The wireless device 1202 may transmit the WLAN RF sensing capabilities 1204 to the sensing entity 1206. The WLAN RF sensing capabilities 1204 may indicate a first measurement type 1210 that is supported by the wireless device 1202 in WLAN RF sensing. The WLAN RF sensing capabilities 1204 may indicate an Nth measurement type 1212 that is supported by the wireless device 1202 in WLAN RF sensing, where N is a positive integer greater than one. In an example, the first measurement type 1210 and the Nth measurement type 1212 may include a range map, a Doppler map, and/or an angle map (e.g., an azimuth map, an elevation map, etc.). In another example, the first measurement type 1210 and the Nth measurement type 1212 may include CSI feedback 1104, image feedback 1106, and/or target feedback 1108. The WLAN RF sensing capabilities 1204 may indicate that the wireless device 1202 supports combinations of measurement types. For instance, the first measurement type 1210 may be range map and the Nth measurement type 1212 may be a Doppler map.

In one aspect, the sensing entity may transmit a request 1214 for the WLAN RF sensing capabilities 1204. The wireless device 1202 may transmit the WLAN RF sensing capabilities 1204 to the sensing entity 1206 based on receiving the request 1214.

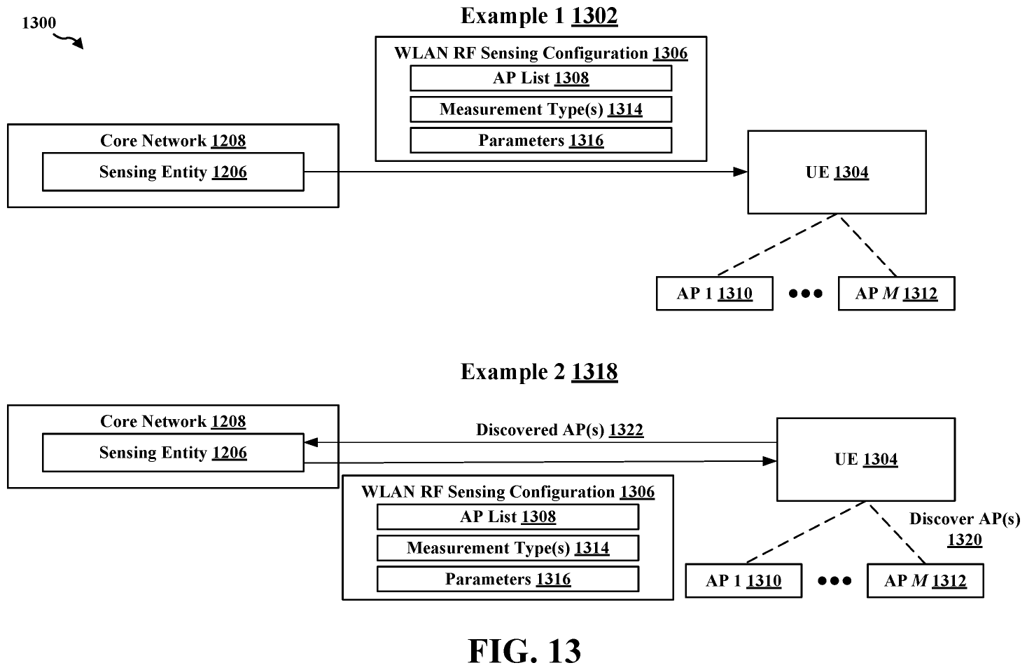

FIG. 13 is a diagram 1300 illustrating example aspects of configuring a UE for WLAN based RF sensing. In a first example 1302, the wireless device 1202 may be a UE 1304. After receiving the WLAN RF sensing capabilities 1204, the sensing entity 1206 may configure the UE 1304 with WLAN based RF sensing. For instance, the sensing entity 1206 may generate and transmit a WLAN RF sensing configuration 1306 based on the WLAN RF sensing capabilities 1204.

The WLAN RF sensing configuration 1306 may include an AP list 1308 that indicates AP(s) with which the UE 1304 is to perform WLAN based RF sensing. In an example, the AP list 1308 may include an identifier for a first AP 1310. The AP list 1308 may also include an identifier for an Mth AP 1312, where M is a positive integer greater than one.

The WLAN RF sensing configuration 1306 may include an indication of measurement type(s) 1314 that the UE 1304 is to perform during the WLAN based RF sensing. The measurement type(s) 1314 may include a range map, a Doppler map, an angle map (e.g., an azimuth map, an elevation map, etc.), CSI feedback 1104, image feedback 1106, and/or target feedback 1108. The measurement type(s) 1314 may also be referred to as feedback types.

The WLAN RF sensing configuration 1306 may include parameters 1316 for the measurement type(s) 1314 for the WLAN based RF sensing. The parameters 1316 may indicate a reporting parameter (i.e., quantization parameter) for the measurement type(s) 1314. The parameters 1316 may specify characteristics for performing WLAN based RF sensing measurements and/or characteristics for reporting the WLAN based RF sensing measurements to the sensing entity 1206 (or another network entity). In an example, the parameters 1316 may indicate that the UE 1304 is to report WLAN based RF sensing measurements for objects that have a velocity that is greater than a threshold velocity within a specified range interval. The parameters 1316 may indicate that a sensing session during which WLAN based RF sensing measurements are performed is periodic, semi-persistent, or aperiodic.

A periodic sensing session may recur at a recurring interval (e.g., once every second, once every minute, etc.). The UE 1304 (or another wireless device) may perform the WLAN based RF sensing measurements at the recurring interval. If the sensing session is periodic, the parameters 1316 may indicate the recurring interval.

A semi-persistent sensing session may be activated and deactivated by the sensing entity 1206. For instance, the sensing entity 1206 may transmit an activation indication to the UE 1304 (or another wireless device) to activate WLAN based RF sensing and the sensing entity 1206 may transmit a deactivation indication to the UE 1304 (or another wireless device) to deactivate WLAN based RF sensing. The UE 1304 (or another wireless device) may perform WLAN based RF sensing measurements at a recurring interval while the WLAN based RF sensing is activated. The UE 1304 (or another wireless device) may continue to perform the WLAN based RF sensing measurements until the deactivation indication is received. If the sensing session is semi-persistent, the parameters 1316 may indicate the recurring interval at which the WLAN based RF sensing measurements are to be performed while the WLAN based RF sensing is activated.

An aperiodic sensing session (i.e., a “one shot” sensing session) may occur upon the UE 1304 receiving an indication from the sensing entity 1206. For instance, the UE 1304 may receive an indication from the sensing entity 1206 and the UE 1304 may perform one or more WLAN based RF sensing measurements based on receiving the indication. The UE 1304 may not perform additional WLAN based RF sensing measurements until the UE 1304 receives an additional indication from the sensing entity 1206. If the sensing session is aperiodic, the parameters 1316 may indicate a number of WLAN based RF sensing measurements that are to be performed upon receiving the indication.

The WLAN RF sensing configuration 1306 may include different parameters for different types of WLAN based RF sensing measurements. For instance, the WLAN RF sensing configuration 1306 may indicate that the UE 1304 is to perform angle measurements in an aperiodic sensing session and that the UE 1304 is to perform Doppler measurements in a periodic sensing session.

The UE 1304 may perform WLAN based RF sensing measurements based on the WLAN RF sensing configuration 1306. For instance, the UE 1304 may perform WLAN based RF sensing measurements based on data/signals transmitted by one or more of the first AP 1310 and/or the Mth AP 1312. The UE 1304 may transmit the WLAN based RF sensing measurements to the sensing entity 1206. The UE 1304 and/or the sensing entity 1206 may perform positioning using the WLAN based RF sensing measurements.

In a second example 1318, at 1320, the UE 1304 may discover AP(s) with which the UE 1304 is able to communicate. In an example, the UE 1304 may discover the first AP 1310 and the Mth AP 1312. The UE 1304 may transmit an indication of the discovered AP(s) 1322 to the sensing entity 1206. The sensing entity 1206 may select one or more of the discovered AP(s) 1322. The sensing entity 1206 may generate the WLAN RF sensing configuration 1306 as described above, where the AP list 1308, the measurement type(s) 1314, and the parameters 1316 are for the discovered AP(s) selected by the sensing entity 1206. In one example, the sensing entity 1206 may select the first AP 1310 (and not the Mth AP 1312). In another example, the sensing entity 1206 may select the first AP 1310 and the Mth AP 1312. The sensing entity 1206 may select the one or more of the discovered AP(s) 1322 based on various factors, such as a threshold number, characteristics of the discovered AP(s), etc.

The sensing entity 1206 may transmit the WLAN RF sensing configuration 1306 to the UE 1304. The UE 1304 may then perform WLAN based RF sensing measurements based on the WLAN RF sensing configuration 1306 as described above. The UE 1304 may transmit the WLAN based RF sensing measurements to the sensing entity 1206 as described above. The UE 1304 and/or the sensing entity 1206 may perform positioning using the WLAN based RF sensing measurements as described above.

In one aspect, the WLAN RF sensing configuration 1306 may indicate that the UE 1304 is to report an independent WLAN sensing result (i.e., a WLAN based RF sensing measurement) for each AP. For instance, the WLAN RF sensing configuration 1306 may indicate that the UE 1304 is to perform a first WLAN based RF sensing measurement for the first AP 1310 and a second WLAN based RF sensing measurement for the Mth AP 1312 and that the UE 1304 is to report the first WLAN based RF sensing measurement and the second WLAN based RF sensing measurement to the sensing entity 1206.

In one aspect, the WLAN RF sensing configuration 1306 may indicate that the UE 1304 is to combine WLAN sensing results (i.e., WLAN based RF sensing measurements) across multiple APs and that the UE 1304 is to report a combined WLAN sensing result to the sensing entity 1206. For instance, the WLAN RF sensing configuration 1306 may indicate that the UE 1304 is to perform a first WLAN based RF sensing measurement for the first AP 1310 and a second WLAN based RF sensing measurement for the Mth AP 1312, compute representative value(s) for the first WLAN based RF sensing measurement and the second WLAN based RF sensing measurement, and transmit the representative value(s) to the sensing entity 1206. In an example, the representative value(s) may be or include an average value.

In one aspect, if a WLAN based RF sensing measurement is not able to be performed by a wireless device or if the wireless device is unable to obtain the WLAN based RF sensing measurement, the wireless device may provide a “sensing error reason” that indicates a reason why the wireless device was unable to perform/obtain the WLAN based RF sensing measurement.

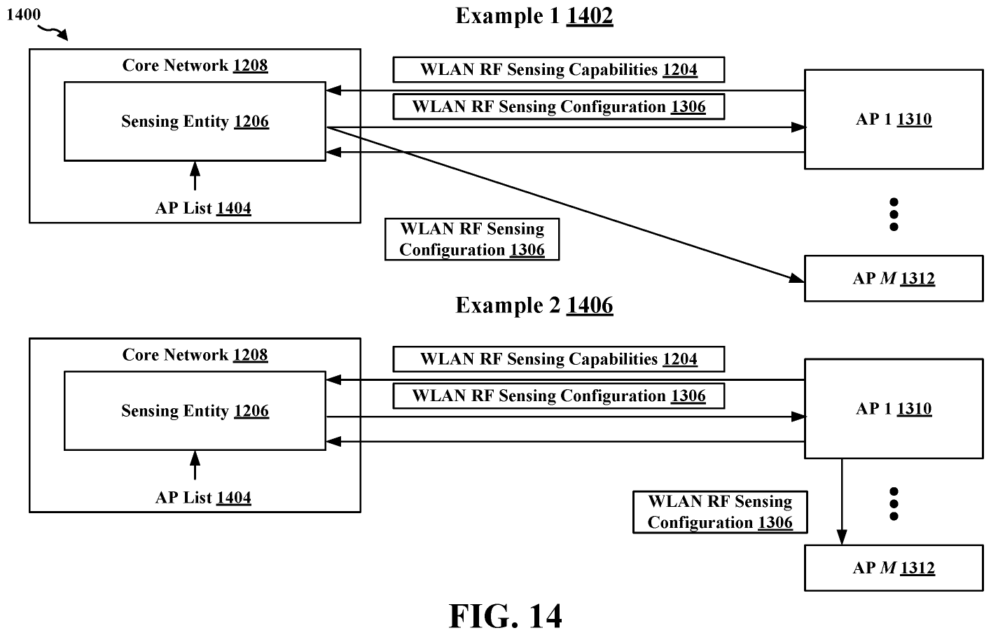

FIG. 14 is a diagram 1400 illustrating example aspects of configuring an AP for WLAN based RF sensing. In a WLAN RF sensing session in which WLAN based RF sensing measurements are performed, an AP can perform WLAN based RF sensing measurements with or without involving UEs. The AP may then share results (i.e., WLAN based RF sensing measurements performed by the AP or another AP) with a sensing entity.

In a first example 1402, the sensing entity 1206 may obtain an AP list 1404 (i.e., a list of available APs), where the AP list 1404 includes identifiers for APs in a certain geographical area. In an example, the sensing entity 1206 may obtain the AP list 1404 from another component/entity of the core network 1208 (e.g., a 5G core network). In an example, the AP list 1404 may include an identifier for the first AP 1310 and the Mth AP 1312. The sensing entity 1206 may exchange sensing capabilities with an AP. In an example, the sensing entity 1206 may transmit a request to the first AP 1310 and the first AP 1310 may transmit WLAN RF sensing capabilities 1204 for the first AP 1310 and/or the Mth AP 1312 to the sensing entity 1206. In another example, the first AP 1310 may transmit the WLAN RF sensing capabilities 1204 to the sensing entity 1206 without receiving a request.

The sensing entity 1206 may configure the first AP 1310 and/or the Mth AP 1312 for a sensing session/measurements, that is, the sensing entity 1206 may generate a WLAN RF sensing configuration 1306 (described above) for the first AP 1310 and the Mth AP 1312 based on the WLAN RF sensing capabilities 1204. As discussed above, the WLAN RF sensing configuration 1306 may be periodic, semi-persistent, or aperiodic. In one aspect, the WLAN RF sensing configuration 1306 may specify or enable a multi-AP session where one or more APs are transmitters during the multi-AP session and where one or more APs are receivers during the multi-AP session. As discussed above, the WLAN RF sensing configuration 1306 may indicate types of measurements that are to be performed. The WLAN RF sensing configuration 1306 may also indicate parameters for the measurements and/or reporting.

The sensing entity 1206 may transmit the WLAN RF sensing configuration 1306 to the first AP 1310 and the Mth AP 1312. The first AP 1310 and the Mth AP 1312 may perform WLAN based RF sensing measurements based on the WLAN RF sensing configuration 1306. In one aspect, the first AP 1310 and the Mth AP 1312 may report the sensing results (i.e., the WLAN based RF sensing measurements) to the sensing entity 1206, that is, the first AP 1310 and the Mth AP 1312 may transmit the sensing results to the sensing entity 1206. In another aspect, the Mth AP 1312 may transmit sensing results for the Mth AP 1312 to the first AP 1310 and the first AP 1310 may transmit sensing results for the first AP 1310 and the sensing results for the Mth AP 1312 to the sensing entity 1206.

In a second example 1406, the sensing entity 1206 may obtain the AP list 1404 as described above in the first example 1402. The sensing entity 1206 may exchange sensing capabilities with an AP as described above. In an example, the sensing entity 1206 may transmit a request to the first AP 1310 and the first AP 1310 may transmit WLAN RF sensing capabilities 1204 for the first AP 1310 and/or the Mth AP 1312 to the sensing entity 1206. In another example, the first AP 1310 may transmit the WLAN RF sensing capabilities 1204 to the sensing entity 1206 without receiving a request.

The sensing entity 1206 may configure the first AP 1310 for a sensing session/measurements, that is, the sensing entity 1206 may generate a WLAN RF sensing configuration 1306 (described above) for the first AP 1310 and the Mth AP 1312 based on the WLAN RF sensing capabilities 1204. The sensing entity 1206 may transmit the WLAN RF sensing configuration 1306 to the first AP 1310. The first AP 1310 may configure the Mth AP 1312 based on the WLAN RF sensing configuration 1306, that is, the first AP 1310 may transmit the WLAN RF sensing configuration 1306 to the Mth AP 1312.

The first AP 1310 and the Mth AP 1312 may perform WLAN based RF sensing measurements based on the WLAN RF sensing configuration 1306. In one aspect, the first AP 1310 and the Mth AP 1312 may report the sensing results (i.e., the WLAN based RF sensing measurements) to the sensing entity 1206, that is, the first AP 1310 and the Mth AP 1312 may transmit the sensing results to the sensing entity 1206. In another aspect, the Mth AP 1312 may transmit sensing results for the Mth AP 1312 to the first AP 1310 and the first AP 1310 may transmit sensing results for the first AP 1310 and the sensing results for the Mth AP 1312 to the sensing entity 1206.

In the first example 1402 and the second example 1406, the sensing entity 1206 may generate and transmit subsequent WLAN RF sensing configurations after transmitting the WLAN RF sensing configuration 1306 or after receiving the sensing results and the first AP 1310 and the Mth AP 1312 may perform and report subsequent WLAN based RF sensing measurements based on the subsequent WLAN RF sensing configurations. In an example, the sensing entity 1206 may generate the subsequent WLAN RF sensing configurations based on a sensing request.

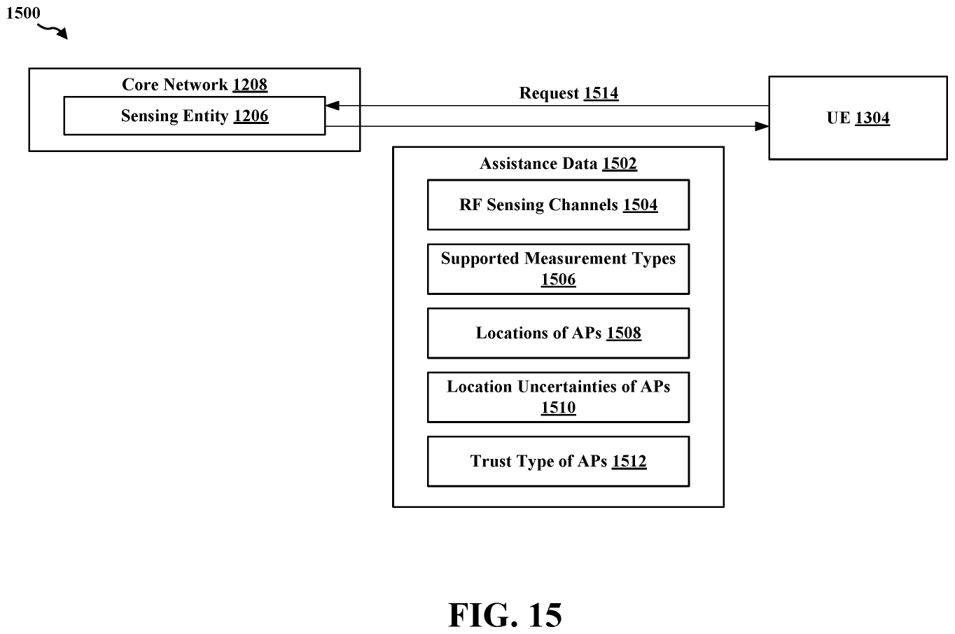

FIG. 15 is a diagram 1500 illustrating example aspects of assistance data for WLAN based RF sensing. In an example, the sensing entity 1206 may provide assistance data 1502 to the UE 1304, that is, the sensing entity 1206 may transmit the assistance data 1502 to the UE 1304.

The assistance data 1502 may include an indication of RF sensing channels 1504 (i.e., WLAN RF sensing channels) for APs (e.g., the first AP 1310, the Mth AP 1312). The assistance data 1502 may include an indication of supported measurement types 1506 (e.g., the first measurement type 1210, the Nth measurement type 1212) of the APs. The assistance data 1502 may include indications of locations 1508 (e.g., latitude, longitude, elevation) of the APs. The assistance data 1502 may include indications of location uncertainties 1510 (i.e., a confidence level) of the APs. The assistance data 1502 may include an indication of trust types 1512 of the APs. In an example, a trust type of an AP may be trusted or non-trusted. A trusted AP may utilize a set of security parameters (e.g., encryption) and hence may be trusted and a non-trusted AP may not utilize a set of security parameters and hence may not be trusted. In an example, a non-trusted AP may be a public AP. The UE 1304 and/or the APs may then perform and report WLAN based RF sensing measurements based on the assistance data 1502.

In one aspect, the UE 1304 may transmit a request 1514 for the assistance data 1502 to the sensing entity 1206. The request 1514 may indicate an AP list (e.g., the AP list 1404) for which the assistance data 1502 is requested. The sensing entity 1206 may transmit the assistance data 1502 based on the request 1514. The UE 1304 may receive a response to the request 1514 as part of a message including the assistance data 1502. If the sensing entity 1206 is unable to provide the assistance data 1502, the sensing entity 1206 may transmit an error reason to the UE 1304, where the error reason indicates a reason as to why the sensing entity 1206 was unable to provide the assistance data 1502 to the UE 1304.

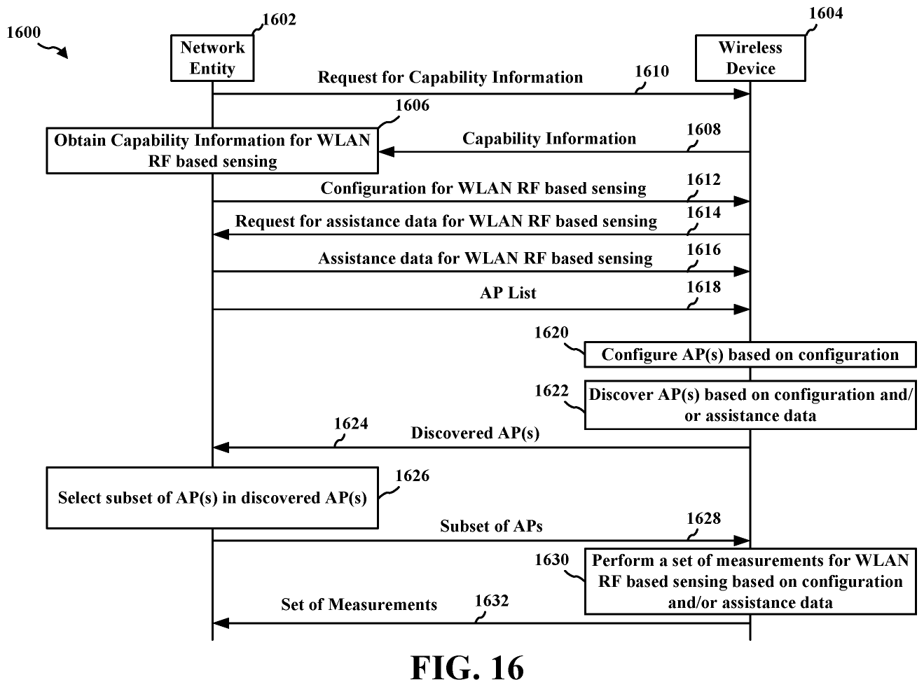

FIG. 16 is a diagram 1600 illustrating example communications between a network entity 1602 and a wireless device 1604. In an example, the network entity 1602 may be or include a sensing entity (e.g., the sensing entity 1206). In an example, the wireless device 1604 may be the wireless device 1202. In an example, the wireless device 1604 may be or include a UE (e.g., the UE 104, the UE 1304, etc.) or an AP (e.g., the first AP 1310, the Mth AP 1312, etc.).

At 1606, the network entity 1602 may obtain capability information for WLAN RF based sensing. For instance, in one aspect, at 1608, the wireless device 1604 may transmit the capability information to the network entity 1602 and the network entity 1602 may receive the capability information. In another aspect, at 1610, the network entity 1602 may transmit a request for the capability information to the wireless device 1604 and the wireless device 1604 may transmit the capability information to the network entity 1602 at 1608 based on receiving the request.

At 1612, the network entity 1602 may generate and transmit a configuration for WLAN RF based sensing to the wireless device 1604. In one aspect, at 1614, the wireless device 1604 may transmit a request for assistance data for WLAN RF based sensing to the network entity 1602. At 1616, the network entity may transmit the assistance data to the wireless device 1604 based on the request.

In one aspect, at 1618, the network entity 1602 may transmit an AP list to the wireless device 1604. At 1620, the wireless device 1604 may configure AP(s) indicated in the AP list based on the configuration. In one aspect, at 1622, the wireless device 1604 may discover AP(s) based on the configuration obtained at 1612 and/or the assistance data received at 1616. At 1624, the wireless device 1604 may transmit an indication of the discovered AP(s) to the network entity 1602. At 1626, the network entity may select a subset of AP(s) in the discovered AP(s), where the wireless device 1604 is to perform WLAN-RF based sensing with the subset of AP(s). At 1628, the network entity 1602 may transmit an indication of the subset of AP(s) to the wireless device 1604.

At 1630, the wireless device 1604 may perform a set of measurements for WLAN based RF sensing based on the configuration and/or the assistance data. In some aspects, the wireless device 1604 may perform the set of measurements for WLAN based RF sensing based on the AP list received at 1618 or the indication of the subset of AP(s) received at 1628. At 1632, the wireless device 1604 may transmit an indication of the set of measurements to the network entity 1602. The network entity 1602 and/or the wireless device 1604 may utilize the set of measurements for positioning purposes.

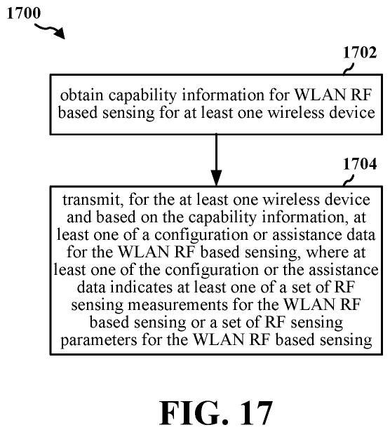

FIG. 17 is a flowchart 1700 of a method of wireless communication. The method may be performed by a network entity (e.g., the core network 120, the sensing entity 1206, the core network 1208, the network entity 1602, the network entity 2160). In an example, the method (including the various aspects detailed below) may be performed by the WLAN RF sensing component 198.

At 1702, the network entity obtains capability information for WLAN radio frequency (RF) based sensing for at least one wireless device. For example, FIG. 16 at 1606 shows that the network entity 1602 may obtain capability information for WLAN RF based sensing for the wireless device 1604. In an example, the capability information may be or include the WLAN RF sensing capabilities 1204. In another example, the capability information may include aspects described above in connection with the third example 902 of FIG. 9. In an example, 1702 may be performed by the WLAN RF sensing component 198.

At 1704, the network entity transmits, for the at least one wireless device and based on the capability information, at least one of a configuration or assistance data for the WLAN RF based sensing, where at least one of the configuration or the assistance data indicates at least one of a set of RF sensing measurements for the WLAN RF based sensing or a set of RF sensing parameters for the WLAN RF based sensing. For example, FIG. 16 at 1612 shows that the network entity 1602 may transmit a configuration for the WLAN RF based sensing to the wireless device 1604. In another example, FIG. 16 at 1616 shows that the network entity 1602 may transmit assistance data for the WLAN RF based sensing to the wireless device 1604. In an example, the configuration may be or include the WLAN RF sensing configuration 1306. In another example, the assistance data may be or include the assistance data 1502. In yet another example, the assistance data may include aspects described above in connection with the sixth example 1004 of FIG. 10. In an example, 1704 may be performed by the WLAN RF sensing component 198.

In one aspect, the capability information may indicate that the at least one wireless device supports at least one of a set of range map measurements, a set of Doppler map measurements, or a set of angle map measurements. For example, the capability information obtained at 1606 may indicate that the wireless device 1604 supports at least one of a set of range map measurements, a set of Doppler map measurements, or a set of angle map measurements.

In some aspects, the network entity may transmit, for the wireless device, a request for the capability information, where obtaining the capability information may include obtaining the capability information based on the request. For example, FIG. 16 at 1610 shows that the network entity 1602 may transmit a request for the capability information to the wireless device 1604.

In one aspect, the at least one wireless device may include at least one UE, and the network entity may transmit, for the at least one UE, a list of APs with which the at least one UE is to perform the WLAN RF based sensing. For example, the wireless device 1604 may be a UE and FIG. 16 at 1618 shows that the network entity 1602 may transmit an AP list to the wireless device 1604, where the wireless device 1604 is to perform WLAN RF based sensing with APs in the AP list. The aforementioned aspect may correspond to the first example 1302 of FIG. 13.

In one aspect, the at least one wireless device may include at least one UE, and the network entity may receive, from the at least one UE and based on at least one of the configuration or the assistance data, a list of APs discovered by the at least one UE. For example, the wireless device 1604 may be a UE and FIG. 16 at 1624 shows that the network entity 1602 may receive, from the wireless device 1604, an indication of the discovered AP(s). The aforementioned aspect may correspond to the second example 1318 of FIG. 13.

In one aspect, the network entity may select a subset of APs in the list of APs based on the WLAN RF based sensing. For example, FIG. 16 at 1626 shows that the network entity 1602 may select a subset of APs in the discovered AP(s). The aforementioned aspect may correspond to the second example 1318 of FIG. 13.

In one aspect, the network entity may transmit, for the at least one UE, an indication of the subset of APs in the list of APs, where the UE is to perform the WLAN RF based sensing with the subset of APs. For example, FIG. 16 at 1628 shows that the network entity 1602 may transmit an indication of the subset of APs in the discovered AP(s). The aforementioned aspect may correspond to the second example 1318 of FIG. 13.

In one aspect, the configuration may further indicate at least one type of RF sensing measurement in the set of RF sensing measurements and a reporting parameter for the at least one type of RF sensing measurement in the set of RF sensing measurements. For example, the at least one type of RF sensing measurement may include aspects described above in connection with the measurement type(s) 1314 and the reporting parameter may include aspects described above in connection with the parameters 1316. In an example, a reporting parameter may be a quantization parameter.

In one aspect, the configuration may further indicate at least one condition or restriction on the set of RF sensing measurements for the WLAN RF based sensing. For example, the parameters 1316 may indicate condition(s) and/or restriction(s) on a set of RF sensing measurements for WLAN RF based sensing.

In one aspect, the at least one wireless device may include at least one UE, and the network entity may receive, from the at least one UE, an indication of the set of RF sensing measurements for the WLAN RF based sensing, where the indication of the set of RF sensing measurements may include at least one of an RF sensing measurement for each AP in a list of APs or a representative RF measurement that is indicative of a combination of the RF sensing measurement for each AP in the list of APs. For example, the wireless device 1604 may be a UE and FIG. 16 at 1632 shows that the network entity 1602 may receive an indication of a set of RF sensing measurements for WLAN RF based sensing. The indication of the set of RF sensing measurements may include at least one of an RF sensing measurement for each AP in a list of APs or a representative RF measurement that is indicative of a combination of the RF sensing measurement for each AP in the list of APs.

In one aspect, the at least one wireless device may include at least one AP, and where the configuration may indicate that the set of RF sensing measurements for the WLAN RF based sensing is to be performed in one of a periodic sensing session of the at least one AP, a semi-persistent sensing session of the at least one AP, or an aperiodic sensing session of the at least one AP. For example, the wireless device 1604 may be an AP and the configuration transmitted at 1612 may indicate that the set of RF sensing measurements for the WLAN RF based sensing is to be performed in one of a periodic sensing session of the at least one AP, a semi-persistent sensing session of the at least one AP, or an aperiodic sensing session of the at least one AP.

In one aspect, the at least one wireless device may include at least one receiving AP and at least one transmitting AP, and the configuration may indicate that the at least one receiving AP and the at least one transmitting AP are to engage in a sensing session associated with the set of RF sensing measurements for the WLAN RF based sensing. For example, the wireless device 1604 may be an AP and the configuration transmitted at 1612 may indicate that at least one receiving AP and the at least one transmitting AP are to engage in a sensing session associated with the set of RF sensing measurements for the WLAN RF based sensing. In an example, the at least one receiving AP may include the first AP 1310 and the at least one transmitting AP may include the Mth AP 1312.

In one aspect, the at least one wireless device may include an AP, and the configuration may indicate that the AP is to configure at least one additional AP for the WLAN RF based sensing based on the configuration. For example, the wireless device 1604 may be an AP and the configuration transmitted at 1612 may indicate that the AP is to configure at least one additional AP for the WLAN RF based sensing based on the configuration. The aforementioned aspect may correspond to the second example 1406 of FIG. 14.

In one aspect, the at least one wireless device may include at least one AP, and the network entity may receive, from the at least one AP and based on the configuration, an indication of the set of RF sensing measurements for the WLAN RF based sensing. For example, the wireless device 1604 may be an AP and FIG. 16 at 1632 shows that the network entity 1602 may receive an indication of the set of RF measurements.

In one aspect, the assistance data for the WLAN RF based sensing may include at least one of a list of WLAN RF sensing channels for APs, at least one type of RF sensing measurement in the set of RF sensing measurements, a set of locations of the APs, a set of location uncertainties of the APs, or a trust type of the APs. For example, the assistance data 1502 may include an indication of RF sensing channels 1504 for APs, an indication of supported measurement types 1506 of the APs, indications of locations 1508 (e.g., latitude, longitude, elevation), indications of location uncertainties 1510 of APs, and/or an indication of trust types 1512 of the APs.

In one aspect, the at least one wireless device may include at least one UE, and the network entity may receive, from the at least one UE, a request for the assistance data, where the request indicates a list of APs for which the assistance data is requested, and where transmitting the assistance data for the WLAN RF based sensing may include transmitting the assistance data for the WLAN RF based sensing based on the request. For example, the wireless device 1604 may be a UE and FIG. 16 at 1614 shows that the network entity 1602 may receive a request for assistance data. Furthermore, transmitting the assistance data at 1616 may be based on receiving the request at 1614.

In one aspect, the at least one wireless device may include at least one of a trusted AP or a non-trusted AP. For example, the wireless device 1604 may be or include a trusted AP or a non-trusted AP.

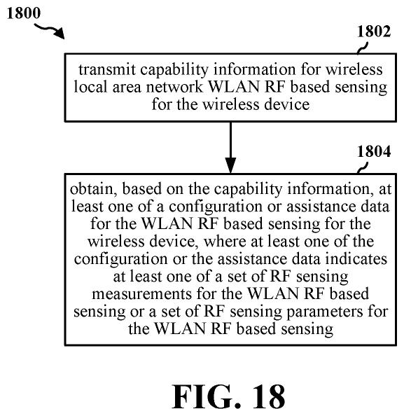

FIG. 18 is a flowchart 1800 of a method of wireless communication. The method may be performed by a wireless device (e.g., the wireless device 1202, the wireless device 1604). In an example, the wireless device may be or include a UE (e.g., the UE 104, the UE 350, the UE 404, the UE 502, the UE 602, the UE 1304, the apparatus 1904). In an example, the wireless device may be or include an AP (e.g., the Wi-Fi™ AP 150, the first AP 1310, the Mth AP 1312). In an example, the method may be performed by the WLAN RF sensing component 199.

At 1802, the wireless device transmits capability information for wireless local area network WLAN radio frequency (RF) based sensing for the wireless device. For example, FIG. 16 at 1608 shows that the wireless device 1604 may transmit capability information for WLAN RF based sensing. In an example, the capability information may be or include the WLAN RF sensing capabilities 1204. In another example, the capability information may include aspects described above in connection with the third example 902 of FIG. 9. In an example, 1802 may be performed by the WLAN RF sensing component 199.

At 1804, the wireless device obtains, based on the capability information, at least one of a configuration or assistance data for the WLAN RF based sensing for the wireless device, where at least one of the configuration or the assistance data indicates at least one of a set of RF sensing measurements for the WLAN RF based sensing or a set of RF sensing parameters for the WLAN RF based sensing. For example, FIG. 16 at 1612 shows that the wireless device 1604 may receive a configuration for the WLAN RF based sensing from the network entity 1602. In another example, FIG. 16 at 1616 shows that the wireless device 1604 may receive assistance data for the WLAN RF based sensing from the network entity 1602. In an example, the configuration may be or include the WLAN RF sensing configuration 1306. In another example, the assistance data may be or include the assistance data 1502. In yet another example, the assistance data may include aspects described above in connection with the sixth example 1004 of FIG. 10. In an example, 1804 may be performed by the WLAN RF sensing component 199.

In one aspect, the capability information may indicate that the wireless device supports at least one of a set of range map measurements, a set of Doppler map measurements, or a set of angle map measurements. For example, the capability information transmitted at 1608 may indicate that the wireless device 1604 supports at least one of a set of range map measurements, a set of Doppler map measurements, or a set of angle map measurements.

In one aspect, the wireless device may receive, from a network entity, a request for the capability information, where transmitting the capability information may include transmitting the capability information based on the request. For example, FIG. 16 at 1610 shows that the wireless device 1604 may receive a request for capability information from the network entity 1602.

In one aspect, the wireless device may include a UE, and the UE may receive, from a network entity, a list of APs with which the UE is to perform the WLAN RF based sensing. For example, the wireless device 1604 may be a UE and FIG. 16 at 1618 shows that the wireless device 1604 may receive an AP list from the network entity 1602, where the wireless device 1604 is to perform WLAN RF based sensing with APs in the AP list. The aforementioned aspect may correspond to the first example 1302 of FIG. 13.

In one aspect, the wireless device may include a UE, and the UE may discover, based on at least one of the configuration or the assistance data, a set of APs. For example, the wireless device 1604 may be a UE and FIG. 16 at 1622 shows that the wireless device 1604 may discover AP(s) based on the configuration and/or the assistance data.

In one aspect, the UE may transmit, for a network entity and based on at least one of the configuration or the assistance data, a first indication of the set of APs. For example, FIG. 16 at 1624 shows that the wireless device 1604 may transmit, to the network entity 1602, an indication of the discovered AP(s). The aforementioned aspect may correspond to the second example 1318 of FIG. 13.

In one aspect, the UE may receive, from the network entity, a second indication of a subset of APs in the set of APs, where the UE is to perform the WLAN RF based sensing with the subset of APs. For example, FIG. 16 at 1628 shows that the wireless device 1604 may receive, from the network entity 1602, an indication of the subset of APs in the discovered AP(s). The aforementioned aspect may correspond to the second example 1318 of FIG. 13.

In one aspect, the configuration may further indicate at least one type of RF sensing measurement in the set of RF sensing measurements and a reporting parameter for the at least one type of RF sensing measurement in the set of RF sensing measurements. For example, the at least one type of RF sensing measurement may include aspects described above in connection with the measurement type(s) 1314 and the reporting parameter may include aspects described above in connection with the parameters 1316. In an example, a reporting parameter may be a quantization parameter.

In one aspect, the configuration may further indicate at least one condition or restriction on the set of RF sensing measurements for the WLAN RF based sensing. For example, the parameters 1316 may indicate condition(s) and/or restriction(s) on a set of RF sensing measurements for WLAN RF based sensing.

In one aspect, the wireless device may include a UE, and the UE may perform, based on at least one of the configuration or the assistance data, the set of RF sensing measurements for the WLAN RF based sensing. For example, the wireless device 1604 may be a UE and FIG. 16 at 1630 shows that the wireless device 1604 may perform a set of RF sensing measurements for WLAN RF based sensing based on the configuration obtained at 1612 and/or the assistance data obtained at 1616.

In one aspect, the UE may transmit, for a network entity, an indication of the performed set of RF sensing measurements for the WLAN RF based sensing, where the indication of the performed set of RF sensing measurements may include at least one of an RF sensing measurement for each AP in a list of APs or a representative RF measurement that is indicative of a combination of the RF sensing measurement for each AP in the list of APs. For example, the wireless device 1604 may be a UE and FIG. 16 at 1632 shows that the wireless device 1604 may transmit an indication of a set of RF sensing measurements for WLAN RF based sensing. The indication of the set of RF sensing measurements may include at least one of an RF sensing measurement for each AP in a list of APs or a representative RF measurement that is indicative of a combination of the RF sensing measurement for each AP in the list of APs.

In one aspect, the wireless device may include an AP, and the configuration may indicate that the set of RF sensing measurements for the WLAN RF based sensing is to be performed in one of a periodic sensing session of the AP, a semi-persistent sensing session of the AP, or an aperiodic sensing session of the AP. For example, the wireless device 1604 may be an AP and the configuration obtained at 1612 may indicate that the set of RF sensing measurements for the WLAN RF based sensing is to be performed in one of a periodic sensing session of the at least one AP, a semi-persistent sensing session of the at least one AP, or an aperiodic sensing session of the at least one AP.

In one aspect, the wireless device may include a receiving AP or a transmitting AP, and the configuration may indicate that the wireless device is to engage in a sensing session associated with the set of RF sensing measurements for the WLAN RF based sensing with at least one additional AP. For example, the wireless device 1604 may be an AP and the configuration obtained at 1612 may indicate that at least one receiving AP and the at least one transmitting AP are to engage in a sensing session associated with the set of RF sensing measurements for the WLAN RF based sensing. In an example, the at least one receiving AP may include the first AP 1310 and the at least one transmitting AP may include the Mth AP 1312.

In one aspect, the wireless device may include an AP, and the configuration may indicate that the AP is to configure at least one additional AP for the WLAN RF based sensing based on the configuration, and the AP may configure the at least one additional AP for the WLAN RF based sensing based on the configuration. For example, the wireless device 1604 may be an AP and the configuration obtained at 1612 may indicate that the AP is to configure at least one additional AP for the WLAN RF based sensing based on the configuration. Furthermore, FIG. 16 at 1620 shows that the wireless device 1604 may configure AP(s) based on the configuration obtained at 1612. The aforementioned aspect may correspond to the second example 1406 of FIG. 14.

In one aspect, the wireless device may include an AP, and the AP may transmit, for a network entity and based on the configuration, an indication of the set of RF sensing measurements for the WLAN RF based sensing. For example, the wireless device 1604 may be an AP and FIG. 16 at 1632 shows that the wireless device 1604 may transmit an indication of the set of RF measurements.

In one aspect, the assistance data for the WLAN RF based sensing may include at least one of a list of WLAN RF sensing channels for APs, at least one type of RF sensing measurement in the set of RF sensing measurements, a set of locations of the APs, a set of location uncertainties of the APs, or a trust type of the APs. For example, the assistance data 1502 may include an indication of RF sensing channels 1504 for APs, an indication of supported measurement types 1506 of the APs, indications of locations 1508 (e.g., latitude, longitude, elevation), indications of location uncertainties 1510 of APs, and/or an indication of trust types 1512 of the APs.

In one aspect, the wireless device may include a UE, and the UE may transmit, for a network entity, a request for the assistance data, where the request indicates a list of APs for which the assistance data is requested, and where receiving the assistance data for the WLAN RF based sensing may include receiving the assistance data for the WLAN RF based sensing based on the request. For example, the wireless device 1604 may be a UE and FIG. 16 at 1614 shows that the wireless device 1604 may transmit a request for assistance data. Furthermore, receiving the assistance data at 1616 may be based on transmitting the request at 1614.

In one aspect, the wireless device may include a trusted AP or a non-trusted AP. For example, the wireless device 1604 may be or include a trusted AP or a non-trusted AP.

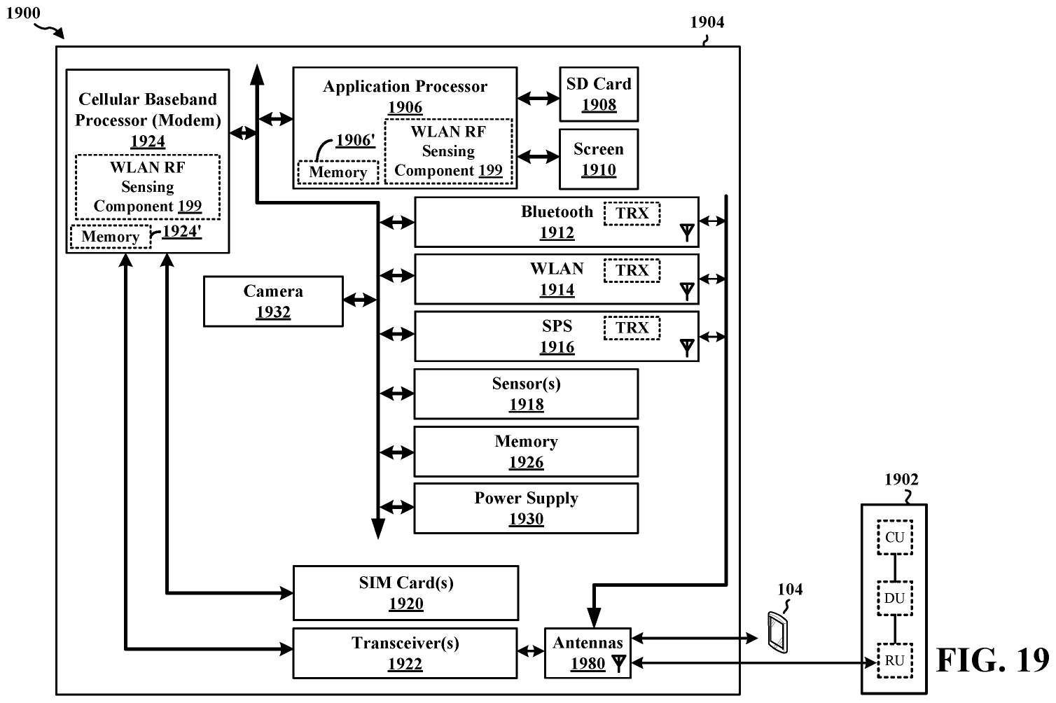

FIG. 19 is a diagram 1900 illustrating an example of a hardware implementation for an apparatus 1904. The apparatus 1904 may be a UE, a component of a UE, or may implement UE functionality. In some aspects, the apparatus 1904 may include a cellular baseband processor 1924 (also referred to as a modem) coupled to one or more transceivers 1922 (e.g., cellular RF transceiver). The cellular baseband processor 1924 may include on-chip memory 1924′. In some aspects, the apparatus 1904 may further include one or more subscriber identity modules (SIM) cards 1920 and an application processor 1906 coupled to a secure digital (SD) card 1908 and a screen 1910. The application processor 1906 may include on-chip memory 1906′. In some aspects, the apparatus 1904 may further include a Bluetooth module 1912, a WLAN module 1914, an SPS module 1916 (e.g., GNSS module), one or more sensor modules 1918 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1926, a power supply 1930, and/or a camera 1932. The Bluetooth module 1912, the WLAN module 1914, and the SPS module 1916 may include an on-chip transceiver (TRX) (or in some cases, just a receiver (RX)). The Bluetooth module 1912, the WLAN module 1914, and the SPS module 1916 may include their own dedicated antennas and/or utilize the antennas 1980 for communication. The cellular baseband processor 1924 communicates through the transceiver(s) 1922 via one or more antennas 1980 with the UE 104 and/or with an RU associated with a network entity 1902. The cellular baseband processor 1924 and the application processor 1906 may each include a computer-readable medium/memory 1924′, 1906′, respectively. The additional memory modules 1926 may also be considered a computer-readable medium/memory. Each computer-readable medium/memory 1924′, 1906′, 1926 may be non-transitory. The cellular baseband processor 1924 and the application processor 1906 are each responsible for general processing, including the execution of software stored on the computer-readable medium/memory. The software, when executed by the cellular baseband processor 1924/application processor 1906, causes the cellular baseband processor 1924/application processor 1906 to perform the various functions described supra. The computer-readable medium/memory may also be used for storing data that is manipulated by the cellular baseband processor 1924/application processor 1906 when executing software. The cellular baseband processor 1924/application processor 1906 may be a component of the UE 350 and may include the memory 360 and/or at least one of the TX processor 368, the RX processor 356, and the controller/processor 359. In one configuration, the apparatus 1904 may be a processor chip (modem and/or application) and include just the cellular baseband processor 1924 and/or the application processor 1906, and in another configuration, the apparatus 1904 may be the entire UE (e.g., see UE 350 of FIG. 3) and include the additional modules of the apparatus 1904.

As discussed supra, the WLAN RF sensing component 199 may be configured to transmit capability information for wireless local area network WLAN RF based sensing for the wireless device. The WLAN RF sensing component 199 may be configured to obtain, based on the capability information, at least one of a configuration or assistance data for the WLAN RF based sensing for the wireless device, where at least one of the configuration or the assistance data indicates at least one of a set of RF sensing measurements for the WLAN RF based sensing or a set of RF sensing parameters for the WLAN RF based sensing. The WLAN RF sensing component 199 may be configured to receive, from a network entity, a request for the capability information, where transmitting the capability information includes transmitting the capability information based on the request. The WLAN RF sensing component 199 may be configured to receive, from a network entity, a list of APs with which the UE is to perform the WLAN RF based sensing. The WLAN RF sensing component 199 may be configured to discover, based on at least one of the configuration or the assistance data, a set of APs. The WLAN RF sensing component 199 may be configured to transmit, for a network entity and based on at least one of the configuration or the assistance data, a first indication of the set of APs. The WLAN RF sensing component 199 may be configured to receive, from the network entity, a second indication of a subset of APs in the set of APs, where the UE is to perform the WLAN RF based sensing with the subset of APs. The WLAN RF sensing component 199 may be configured to perform, based on at least one of the configuration or the assistance data, the set of RF sensing measurements for the WLAN RF based sensing. The WLAN RF sensing component 199 may be configured to transmit, for a network entity, an indication of the performed set of RF sensing measurements for the WLAN RF based sensing, where the indication of the performed set of RF sensing measurements includes at least one of an RF sensing measurement for each AP in a list of APs or a representative RF measurement that is indicative of a combination of the RF sensing measurement for each AP in the list of APs. The WLAN RF sensing component 199 may be configured to configure the at least one additional AP for the WLAN RF based sensing based on the configuration. The WLAN RF sensing component 199 may be configured to transmit, for a network entity and based on the configuration, an indication of the set of RF sensing measurements for the WLAN RF based sensing. The WLAN RF sensing component 199 may be configured to transmit, for a network entity, a request for the assistance data, where the request indicates a list of APs for which the assistance data is requested, and where receiving the assistance data for the WLAN RF based sensing includes receiving the assistance data for the WLAN RF based sensing based on the request. The WLAN RF sensing component 199 may be within the cellular baseband processor 1924, the application processor 1906, or both the cellular baseband processor 1924 and the application processor 1906. The WLAN RF sensing component 199 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1904 may include a variety of components configured for various functions. In one configuration, the apparatus 1904, and in particular the cellular baseband processor 1924 and/or the application processor 1906, may include means for transmitting capability information for wireless local area network (WLAN) radio frequency (RF) based sensing for the wireless device. In one configuration, the apparatus 1904, and in particular the cellular baseband processor 1924 and/or the application processor 1906, may include means for obtaining, based on the capability information, at least one of a configuration or assistance data for the WLAN RF based sensing for the wireless device, where at least one of the configuration or the assistance data indicates at least one of a set of RF sensing measurements for the WLAN RF based sensing or a set of RF sensing parameters for the WLAN RF based sensing. In one configuration, the apparatus 1904, and in particular the cellular baseband processor 1924 and/or the application processor 1906, may include means for receiving, from a network entity, a request for the capability information, where transmitting the capability information includes transmitting the capability information based on the request. In one configuration, the apparatus 1904, and in particular the cellular baseband processor 1924 and/or the application processor 1906, may include means for receiving, from a network entity, a list of access points (APs) with which the UE is to perform the WLAN RF based sensing. In one configuration, the apparatus 1904, and in particular the cellular baseband processor 1924 and/or the application processor 1906, may include means for discovering, based on at least one of the configuration or the assistance data, a set of access points (APs). In one configuration, the apparatus 1904, and in particular the cellular baseband processor 1924 and/or the application processor 1906, may include means for transmitting, for a network entity and based on at least one of the configuration or the assistance data, a first indication of the set of APs. In one configuration, the apparatus 1904, and in particular the cellular baseband processor 1924 and/or the application processor 1906, may include means for receiving, from the network entity, a second indication of a subset of APs in the set of APs, where the UE is to perform the WLAN RF based sensing with the subset of APs. In one configuration, the apparatus 1904, and in particular the cellular baseband processor 1924 and/or the application processor 1906, may include means for performing, based on at least one of the configuration or the assistance data, the set of RF sensing measurements for the WLAN RF based sensing. In one configuration, the apparatus 1904, and in particular the cellular baseband processor 1924 and/or the application processor 1906, may include means for transmitting, for a network entity, an indication of the performed set of RF sensing measurements for the WLAN RF based sensing, where the indication of the performed set of RF sensing measurements includes at least one of an RF sensing measurement for each access point (AP) in a list of APs or a representative RF measurement that is indicative of a combination of the RF sensing measurement for each AP in the list of APs. In one configuration, the apparatus 1904, and in particular the cellular baseband processor 1924 and/or the application processor 1906, may include means for configuring the at least one additional AP for the WLAN RF based sensing based on the configuration. In one configuration, the apparatus 1904, and in particular the cellular baseband processor 1924 and/or the application processor 1906, may include means for transmitting, for a network entity and based on the configuration, an indication of the set of RF sensing measurements for the WLAN RF based sensing. In one configuration, the apparatus 1904, and in particular the cellular baseband processor 1924 and/or the application processor 1906, may include means for transmitting, for a network entity, a request for the assistance data, where the request indicates a list of access points (APs) for which the assistance data is requested, and where receiving the assistance data for the WLAN RF based sensing includes receiving the assistance data for the WLAN RF based sensing based on the request. The means may be the WLAN RF sensing component 199 of the apparatus 1904 configured to perform the functions recited by the means. As described supra, the apparatus 1904 may include the TX processor 368, the RX processor 356, and the controller/processor 359. As such, in one configuration, the means may be the TX processor 368, the RX processor 356, and/or the controller/processor 359 configured to perform the functions recited by the means.

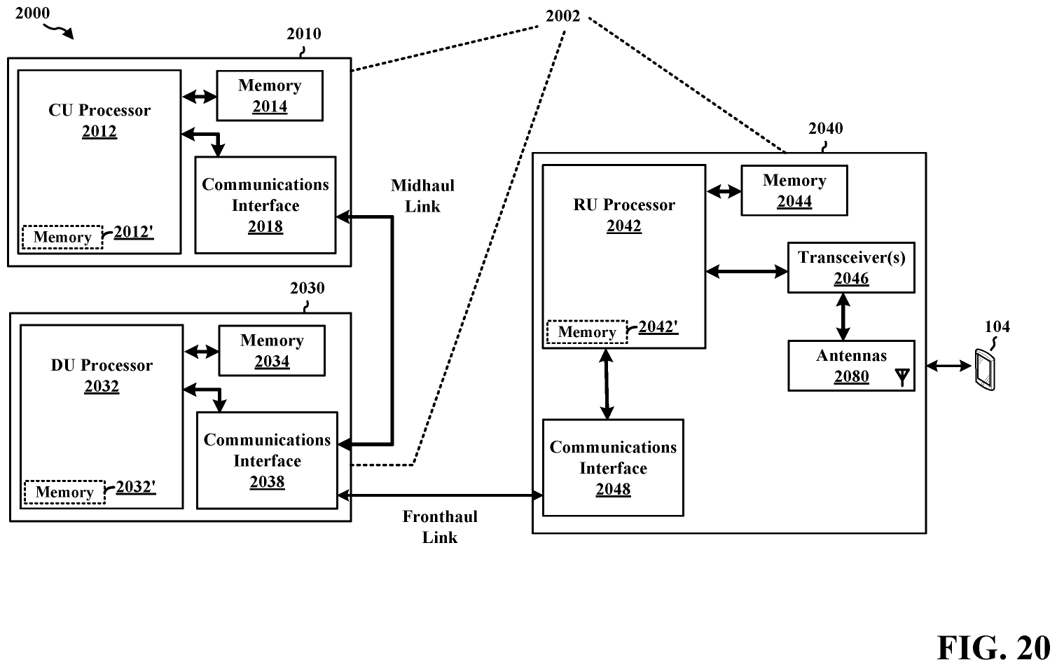

FIG. 20 is a diagram 2000 illustrating an example of a hardware implementation for a network entity 2002. The network entity 2002 may be a BS, a component of a BS, or may implement BS functionality. The network entity 2002 may include at least one of a CU 2010, a DU 2030, or an RU 2040. The network entity 2002 may include the CU 2010; both the CU 2010 and the DU 2030; each of the CU 2010, the DU 2030, and the RU 2040; the DU 2030; both the DU 2030 and the RU 2040; or the RU 2040. The CU 2010 may include a CU processor 2012. The CU processor 2012 may include on-chip memory 2012′. In some aspects, the CU 2010 may further include additional memory modules 2014 and a communications interface 2018. The CU 2010 communicates with the DU 2030 through a midhaul link, such as an F1 interface. The DU 2030 may include a DU processor 2032. The DU processor 2032 may include on-chip memory 2032′. In some aspects, the DU 2030 may further include additional memory modules 2034 and a communications interface 2038. The DU 2030 communicates with the RU 2040 through a fronthaul link. The RU 2040 may include an RU processor 2042. The RU processor 2042 may include on-chip memory 2042′. In some aspects, the RU 2040 may further include additional memory modules 2044, one or more transceivers 2046, antennas 2080, and a communications interface 2048. The RU 2040 communicates with the UE 104. The on-chip memory 2012′, 2032′. 2042′ and the additional memory modules 2014, 2034, 2044 may each be considered a computer-readable medium/memory. Each computer-readable medium/memory may be non-transitory. Each of the processors 2012, 2032, 2042 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

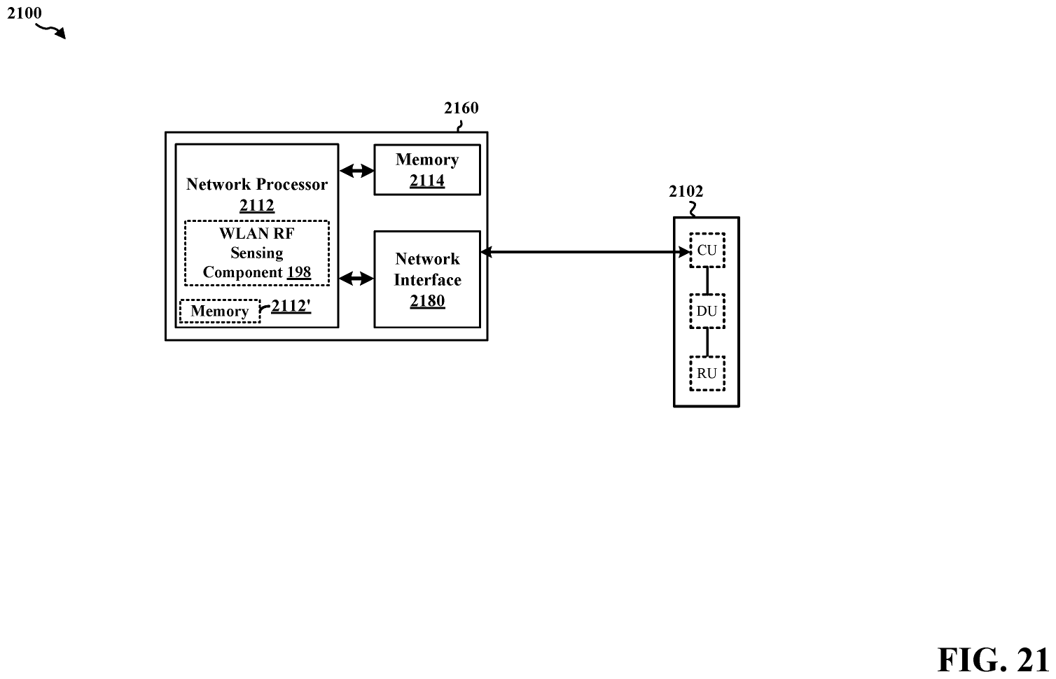

FIG. 21 is a diagram 2100 illustrating an example of a hardware implementation for a network entity 2160. In one example, the network entity 2160 may be within the core network 120. The network entity 2160 may include a network processor 2112. The network processor 2112 may include on-chip memory 2112′. In some aspects, the network entity 2160 may further include additional memory modules 2114. The network entity 2160 communicates via the network interface 2180 directly (e.g., backhaul link) or indirectly (e.g., through a RIC) with the CU 2102. The on-chip memory 2112′ and the additional memory modules 2114 may each be considered a computer-readable medium/memory. Each computer-readable medium/memory may be non-transitory. The processor 2112 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the WLAN RF sensing component 198 may be configured to obtain capability information for WLAN RF based sensing for at least one wireless device. The WLAN RF sensing component 198 may be configured to transmit, for the at least one wireless device and based on the capability information, at least one of a configuration or assistance data for the WLAN RF based sensing, where at least one of the configuration or the assistance data indicates at least one of a set of RF sensing measurements for the WLAN RF based sensing or a set of RF sensing parameters for the WLAN RF based sensing. The WLAN RF sensing component 198 may be configured to transmit, for the wireless device, a request for the capability information, where obtaining the capability information includes obtaining the capability information based on the request. The WLAN RF sensing component 198 may be configured to transmit, for the at least one UE, a list of APs with which the at least one UE is to perform the WLAN RF based sensing. The WLAN RF sensing component 198 may be configured to receive, from the at least one UE and based on at least one of the configuration or the assistance data, a list of APs discovered by the at least one UE. The WLAN RF sensing component 198 may be configured to select a subset of APs in the list of APs based on the WLAN RF based sensing. The WLAN RF sensing component 198 may be configured to transmit, for the at least one UE, an indication of the subset of APs in the list of APs, where the UE is to perform the WLAN RF based sensing with the subset of APs. The WLAN RF sensing component 198 may be configured to receive, from the at least one UE, an indication of the set of RF sensing measurements for the WLAN RF based sensing, where the indication of the set of RF sensing measurements includes at least one of an RF sensing measurement for each AP in a list of APs or a representative RF measurement that is indicative of a combination of the RF sensing measurement for each AP in the list of APs. The WLAN RF sensing component 198 may be configured to receive, from the at least one AP and based on the configuration, an indication of the set of RF sensing measurements for the WLAN RF based sensing. The WLAN RF sensing component 198 may be configured to receive, from the at least one UE, a request for the assistance data, where the request indicates a list of APs for which the assistance data is requested, and where transmitting the assistance data for the WLAN RF based sensing includes transmitting the assistance data for the WLAN RF based sensing based on the request. The WLAN RF sensing component 198 may be within the processor 2112. The WLAN RF sensing component 198 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2160 may include a variety of components configured for various functions. In one configuration, the network entity 2160 may include means for obtaining capability information for wireless local area network (WLAN) radio frequency (RF) based sensing for at least one wireless device. In one configuration, the network entity 2160 may include means for transmitting, for the at least one wireless device and based on the capability information, at least one of a configuration or assistance data for the WLAN RF based sensing, where at least one of the configuration or the assistance data indicates at least one of a set of RF sensing measurements for the WLAN RF based sensing or a set of RF sensing parameters for the WLAN RF based sensing. In one configuration, the network entity 2160 may include means for transmitting, for the wireless device, a request for the capability information, where obtaining the capability information includes obtaining the capability information based on the request. In one configuration, the network entity 2160 may include means for transmitting, for the at least one UE, a list of access points (APs) with which the at least one UE is to perform the WLAN RF based sensing. In one configuration, the network entity 2160 may include means for receiving, from the at least one UE and based on at least one of the configuration or the assistance data, a list of access points (APs) discovered by the at least one UE. In one configuration, the network entity 2160 may include means for selecting a subset of APs in the list of APs based on the WLAN RF based sensing. In one configuration, the network entity 2160 may include means for transmitting, for the at least one UE, an indication of the subset of APs in the list of APs, where the UE is to perform the WLAN RF based sensing with the subset of APs. In one configuration, the network entity 2160 may include means for receiving, from the at least one UE, an indication of the set of RF sensing measurements for the WLAN RF based sensing, where the indication of the set of RF sensing measurements includes at least one of an RF sensing measurement for each access point (AP) in a list of APs or a representative RF measurement that is indicative of a combination of the RF sensing measurement for each AP in the list of APs. In one configuration, the network entity 2160 may include means for receiving, from the at least one AP and based on the configuration, an indication of the set of RF sensing measurements for the WLAN RF based sensing. In one configuration, the network entity 2160 may include means for receiving, from the at least one UE, a request for the assistance data, where the request indicates a list of access points (APs) for which the assistance data is requested, and where transmitting the assistance data for the WLAN RF based sensing includes transmitting the assistance data for the WLAN RF based sensing based on the request. The means may be the WLAN RF sensing component 198 of the network entity 2160 configured to perform the functions recited by the means.

A cellular communication system may utilize different techniques for positioning in order to ascertain a location of a UE or another object. WLAN communication systems may utilize WLAN RF sensing for positioning purposes. However, the inter-play between positioning in cellular communication systems and WLAN communication systems may not be well-defined with respect to particular features in WLAN RF sensing, thus leading to technical challenges. For instance, a cellular communication system may not be configured to facilitate positioning without the involvement of a UE.

Various technologies pertaining to WLAN based RF sensing in cellular systems are described herein. In an example, a network entity obtains capability information for WLAN RF based sensing for at least one wireless device. The network entity transmits, for the at least one wireless device and based on the capability information, at least one of a configuration or assistance data for the WLAN RF based sensing, where at least one of the configuration or the assistance data indicates at least one of a set of RF sensing measurements for the WLAN RF based sensing or a set of RF sensing parameters for the WLAN RF based sensing. Vis-à-vis transmitting at least one of the configuration or the assistance data for the WLAN RF based sensing, the network entity may enable the at least one wireless device to perform enhanced positioning techniques. For instance, the configuration and/or the assistance data may enable the at least one wireless device to ascertain a location of the wireless device or another object in a more accurate manner compared to wireless devices that do not receive the configuration (which is based on the capability information) or the assistance data for the WLAN RF based sensing.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a network entity, comprising: obtaining capability information for wireless local area network (WLAN) radio frequency (RF) based sensing for at least one wireless device; and transmitting, for the at least one wireless device and based on the capability information, at least one of a configuration or assistance data for the WLAN RF based sensing, wherein at least one of the configuration or the assistance data indicates at least one of a set of RF sensing measurements for the WLAN RF based sensing or a set of RF sensing parameters for the WLAN RF based sensing.

Aspect 2 is the method of aspect 1, wherein the capability information indicates that the at least one wireless device supports at least one of a set of range map measurements, a set of Doppler map measurements, or a set of angle map measurements.

Aspect 3 is the method of any of aspects 1-2, further comprising: transmitting, for the wireless device, a request for the capability information, wherein obtaining the capability information comprises obtaining the capability information based on the request.

Aspect 4 is the method of any of aspects 1-3, wherein the at least one wireless device comprises at least one user equipment (UE), the method further comprising: transmitting, for the at least one UE, a list of access points (APs) with which the at least one UE is to perform the WLAN RF based sensing.

Aspect 5 is the method of any of aspects 1-3, wherein the at least one wireless device comprises at least one user equipment (UE), the method further comprising: receiving, from the at least one UE and based on at least one of the configuration or the assistance data, a list of access points (APs) discovered by the at least one UE; selecting a subset of APs in the list of APs based on the WLAN RF based sensing; and transmitting, for the at least one UE, an indication of the subset of APs in the list of APs, wherein the UE is to perform the WLAN RF based sensing with the subset of APs.

Aspect 6 is the method of any of aspects 1-5, wherein the configuration further indicates at least one type of RF sensing measurement in the set of RF sensing measurements and a reporting parameter for the at least one type of RF sensing measurement in the set of RF sensing measurements.

Aspect 7 is the method of any of aspects 1-6, wherein the configuration further indicates at least one condition or restriction on the set of RF sensing measurements for the WLAN RF based sensing.

Aspect 8 is the method of any of aspects 1-7, wherein the at least one wireless device comprises at least one user equipment (UE), the method further comprising: receiving, from the at least one UE, an indication of the set of RF sensing measurements for the WLAN RF based sensing, wherein the indication of the set of RF sensing measurements comprises at least one of an RF sensing measurement for each access point (AP) in a list of APs or a representative RF measurement that is indicative of a combination of the RF sensing measurement for each AP in the list of APs.

Aspect 9 is the method of any of aspects 1-3 and/or aspects 6-7, wherein the at least one wireless device comprises at least one access point (AP), and wherein the configuration indicates that the set of RF sensing measurements for the WLAN RF based sensing is to be performed in one of a periodic sensing session of the at least one AP, a semi-persistent sensing session of the at least one AP, or an aperiodic sensing session of the at least one AP.

Aspect 10 is the method of any of aspects 1-3, 6-7, or 9, wherein the at least one wireless device comprises at least one receiving access point (AP) and at least one transmitting AP, and wherein the configuration indicates that the at least one receiving AP and the at least one transmitting AP are to engage in a sensing session associated with the set of RF sensing measurements for the WLAN RF based sensing.

Aspect 11 is the method of any of aspects 1-3, 6-7, or 9-10, wherein the at least one wireless device comprises an access point (AP), and wherein the configuration indicates that the AP is to configure at least one additional AP for the WLAN RF based sensing based on the configuration.

Aspect 12 is the method of any of aspects 1-3, 6-7, or 9-11, wherein the at least one wireless device comprises at least one access point (AP), the method further comprising: receiving, from the at least one AP and based on the configuration, an indication of the set of RF sensing measurements for the WLAN RF based sensing.

Aspect 13 is the method of any of aspects 1-12, wherein the assistance data for the WLAN RF based sensing comprises at least one of a list of WLAN RF sensing channels for access points (APs), at least one type of RF sensing measurement in the set of RF sensing measurements, a set of locations of the APs, a set of location uncertainties of the APs, or a trust type of the APs.

Aspect 14 is the method of any of aspects 1-8 or 13, wherein the at least one wireless device comprises at least one user equipment (UE), the method further comprising: receiving, from the at least one UE, a request for the assistance data, wherein the request indicates a list of access points (APs) for which the assistance data is requested, and wherein transmitting the assistance data for the WLAN RF based sensing comprises transmitting the assistance data for the WLAN RF based sensing based on the request.

Aspect 15 is the method of any of aspects 1-3, 6-7, or 9-13, wherein the at least one wireless device comprises at least one of a trusted access point (AP) or a non-trusted AP.

Aspect 16 is an apparatus for wireless communication at a network entity comprising a memory and at least one processor coupled to the memory and based at least in part on information stored in the memory, the at least one processor is configured to perform a method in accordance with any of aspects 1-15.

Aspect 17 is an apparatus for wireless communications, comprising means for performing a method in accordance with any of aspects 1-15.

Aspect 18 is the apparatus of aspect 16 or 17 further comprising at least one of a transceiver or an antenna coupled to the at least one processor, wherein the at least one processor is configured to transmit at least one of the configuration or the assistance data via at least one of the transceiver or the antenna.

Aspect 19 is a computer-readable medium (e.g., a non-transitory computer-readable medium) comprising instructions that, when executed by at least one processor, cause the at least one processor to perform a method in accordance with any of aspects 1-15.

Aspect 20 is a method of wireless communication at a wireless device, comprising: transmitting capability information for wireless local area network (WLAN) radio frequency (RF) based sensing for the wireless device; and obtaining, based on the capability information, at least one of a configuration or assistance data for the WLAN RF based sensing for the wireless device, wherein at least one of the configuration or the assistance data indicates at least one of a set of RF sensing measurements for the WLAN RF based sensing or a set of RF sensing parameters for the WLAN RF based sensing.

Aspect 21 is the method of aspect 20, wherein the capability information indicates that the wireless device supports at least one of a set of range map measurements, a set of Doppler map measurements, or a set of angle map measurements.

Aspect 22 is the method of any of aspects 20-21, further comprising: receiving, from a network entity, a request for the capability information, wherein transmitting the capability information comprises transmitting the capability information based on the request.

Aspect 23 is the method of any of aspects 20-22, wherein the wireless device comprises a user equipment (UE), the method further comprising: receiving, from a network entity, a list of access points (APs) with which the UE is to perform the WLAN RF based sensing.

Aspect 24 is the method of any of aspects 20-22, wherein the wireless device comprises a user equipment (UE), the method further comprising: discovering, based on at least one of the configuration or the assistance data, a set of access points (APs); transmitting, for a network entity and based on at least one of the configuration or the assistance data, a first indication of the set of APs; and receiving, from the network entity, a second indication of a subset of APs in the set of APs, wherein the UE is to perform the WLAN RF based sensing with the subset of APs.

Aspect 25 is the method of any of aspects 20-24, wherein the configuration further indicates at least one type of RF sensing measurement in the set of RF sensing measurements and a reporting parameter for the at least one type of RF sensing measurement in the set of RF sensing measurements.

Aspect 26 is the method of any of aspects 20-25, wherein the configuration further indicates at least one condition or restriction on the set of RF sensing measurements for the WLAN RF based sensing.

Aspect 27 is the method of any of aspects 20-26, wherein the wireless device comprises a user equipment (UE), the method further comprising: performing, based on at least one of the configuration or the assistance data, the set of RF sensing measurements for the WLAN RF based sensing; and transmitting, for a network entity, an indication of the performed set of RF sensing measurements for the WLAN RF based sensing, wherein the indication of the performed set of RF sensing measurements comprises at least one of an RF sensing measurement for each access point (AP) in a list of APs or a representative RF measurement that is indicative of a combination of the RF sensing measurement for each AP in the list of APs.

Aspect 28 is the method of any of aspects 20-22 or 25-26, wherein the wireless device comprises an access point (AP), and wherein the configuration indicates that the set of RF sensing measurements for the WLAN RF based sensing is to be performed in one of a periodic sensing session of the AP, a semi-persistent sensing session of the AP, or an aperiodic sensing session of the AP.

Aspect 29 is the method of any of aspects 20-22, 25-26, or 28, wherein the wireless device comprises a receiving access point (AP) or a transmitting AP, and wherein the configuration indicates that the wireless device is to engage in a sensing session associated with the set of RF sensing measurements for the WLAN RF based sensing with at least one additional AP.

Aspect 30 is the method of any of aspects 20-22, 25-26, or 28-29, wherein the wireless device comprises an access point (AP), and wherein the configuration indicates that the AP is to configure at least one additional AP for the WLAN RF based sensing based on the configuration, the method further comprising: configuring the at least one additional AP for the WLAN RF based sensing based on the configuration.

Aspect 31 is the method of any of aspects 20-22, 25-26, or 28-30, wherein the wireless device comprises an access point (AP), the method further comprising: transmitting, for a network entity and based on the configuration, an indication of the set of RF sensing measurements for the WLAN RF based sensing.

Aspect 32 is the method of any of aspects 20-31, wherein the assistance data for the WLAN RF based sensing comprises at least one of a list of WLAN RF sensing channels for access points (APs), at least one type of RF sensing measurement in the set of RF sensing measurements, a set of locations of the APs, a set of location uncertainties of the APs, or a trust type of the APs.

Aspect 33 is the method of any of aspects 20-27 or 32, wherein the wireless device comprises a user equipment (UE), the method further comprising: transmitting, for a network entity, a request for the assistance data, wherein the request indicates a list of access points (APs) for which the assistance data is requested, and wherein receiving the assistance data for the WLAN RF based sensing comprises receiving the assistance data for the WLAN RF based sensing based on the request.

Aspect 34 is the method of any of aspects 20-22, 25-26, or 28-32, wherein the wireless device comprises a trusted access point (AP) or a non-trusted AP.

Aspect 35 is an apparatus for wireless communication at a wireless device comprising a memory and at least one processor coupled to the memory and based at least in part on information stored in the memory, the at least one processor is configured to perform a method in accordance with any of aspects 20-34.

Aspect 36 is an apparatus for wireless communications, comprising means for performing a method in accordance with any of aspects 20-34.

Aspect 37 is the apparatus of aspect 35 or 36 further comprising at least one of a transceiver or an antenna coupled to the at least one processor, wherein the at least one processor is configured to obtain at least one of the configuration or the assistance data via at least one of the transceiver or the antenna.

Aspect 38 is a computer-readable medium (e.g., a non-transitory computer-readable medium) comprising instructions that, when executed by at least one processor, cause the at least one processor to perform a method in accordance with any of aspects 20-34.

What is claimed is:

1. An apparatus for wireless communication at a wireless device, comprising:
a memory; and
at least one processor coupled to the memory and, based at least in part on information stored in the memory, the at least one processor is configured to:
transmit capability information for wireless local area network (WLAN) radio frequency (RF) based sensing for the wireless device; and
obtain, based on the capability information, at least one of a configuration or assistance data for the WLAN RF based sensing for the wireless device, wherein at least one of the configuration or the assistance data indicates at least one of a set of RF sensing measurements for the WLAN RF based sensing or a set of RF sensing parameters for the WLAN RF based sensing.

2. The apparatus of claim 1, wherein the capability information indicates that the wireless device supports at least one of a set of range map measurements, a set of Doppler map measurements, or a set of angle map measurements.

3. The apparatus of claim 1, wherein the at least one processor is further configured to:
receive, from a network entity, a request for the capability information, wherein to transmit the capability information, the at least one processor is configured to transmit the capability information based on the request.

4. The apparatus of claim 1, wherein the wireless device comprises a user equipment (UE), wherein the at least one processor is further configured to:
receive, from a network entity, a list of access points (APs) with which the UE is to perform the WLAN RF based sensing.

5. The apparatus of claim 1, wherein the wireless device comprises a user equipment (UE), wherein the at least one processor is further configured to:
discover, based on at least one of the configuration or the assistance data, a set of access points (APs);
transmit, for a network entity and based on at least one of the configuration or the assistance data, a first indication of the set of APs; and
receive, from the network entity, a second indication of a subset of APs in the set of APs, wherein the UE is to perform the WLAN RF based sensing with the subset of APs.

6. The apparatus of claim 1, wherein the configuration further indicates at least one type of RF sensing measurement in the set of RF sensing measurements and a reporting parameter for the at least one type of RF sensing measurement in the set of RF sensing measurements.

7. The apparatus of claim 1, wherein the configuration further indicates at least one condition or restriction on the set of RF sensing measurements for the WLAN RF based sensing.

8. The apparatus of claim 1, wherein the wireless device comprises a user equipment (UE), wherein the at least one processor is further configured to:
perform, based on at least one of the configuration or the assistance data, the set of RF sensing measurements for the WLAN RF based sensing; and
transmit, for a network entity, an indication of the performed set of RF sensing measurements for the WLAN RF based sensing, wherein the indication of the performed set of RF sensing measurements includes at least one of an RF sensing measurement for each access point (AP) in a list of APs or a representative RF measurement that is indicative of a combination of the RF sensing measurement for each AP in the list of APs.

9. The apparatus of claim 1, wherein the wireless device comprises an access point (AP), and wherein the configuration indicates that the set of RF sensing measurements for the WLAN RF based sensing is to be performed in one of a periodic sensing session of the AP, a semi-persistent sensing session of the AP, or an aperiodic sensing session of the AP.

10. The apparatus of claim 1, wherein the wireless device comprises a receiving access point (AP) or a transmitting AP, and wherein the configuration indicates that the wireless device is to engage in a sensing session associated with the set of RF sensing measurements for the WLAN RF based sensing with at least one additional AP.

11. The apparatus of claim 1, wherein the wireless device comprises an access point (AP), and wherein the configuration indicates that the AP is to configure at least one additional AP for the WLAN RF based sensing based on the configuration, and wherein the at least one processor is further configured to:
configure the at least one additional AP for the WLAN RF based sensing based on the configuration.

12. The apparatus of claim 1, wherein the wireless device comprises an access point (AP), wherein the at least one processor is further configured to:
transmit, for a network entity and based on the configuration, an indication of the set of RF sensing measurements for the WLAN RF based sensing.

13. The apparatus of claim 1, wherein the assistance data for the WLAN RF based sensing comprises at least one of a list of WLAN RF sensing channels for access points (APs), at least one type of RF sensing measurement in the set of RF sensing measurements, a set of locations of the APs, a set of location uncertainties of the APs, or a trust type of the APs.

14. The apparatus of claim 1, wherein the wireless device comprises a user equipment (UE), wherein the at least one processor is further configured to:
transmit, for a network entity, a request for the assistance data, wherein the request indicates a list of access points (APs) for which the assistance data is requested, and wherein to receive the assistance data for the WLAN RF based sensing, the at least one processor is configured to receive the assistance data for the WLAN RF based sensing based on the request.

15. The apparatus of claim 1, wherein the wireless device comprises a trusted access point (AP) or a non-trusted AP.

16. The apparatus of claim 1, further comprising at least one of a transceiver or an antenna coupled to the at least one processor, wherein to obtain at least one of the configuration or the assistance data, the at least one processor is configured to obtain at least one of the configuration or the assistance data via at least one of the transceiver or the antenna.

17. A method of wireless communication at a wireless device, comprising:
transmitting capability information for wireless local area network (WLAN) radio frequency (RF) based sensing for the wireless device; and
obtaining, based on the capability information, at least one of a configuration or assistance data for the WLAN RF based sensing for the wireless device, wherein at least one of the configuration or the assistance data indicates at least one of a set of RF sensing measurements for the WLAN RF based sensing or a set of RF sensing parameters for the WLAN RF based sensing.

18. An apparatus for wireless communication at a network entity, comprising:
a memory; and
at least one processor coupled to the memory and, based at least in part on information stored in the memory, the at least one processor is configured to:
obtain capability information for wireless local area network (WLAN) radio frequency (RF) based sensing for at least one wireless device; and
transmit, for the at least one wireless device and based on the capability information, at least one of a configuration or assistance data for the WLAN RF based sensing, wherein at least one of the configuration or the assistance data indicates at least one of a set of RF sensing measurements for the WLAN RF based sensing or a set of RF sensing parameters for the WLAN RF based sensing.

19. The apparatus of claim 18, wherein the capability information indicates that the at least one wireless device supports at least one of a set of range map measurements, a set of Doppler map measurements, or a set of angle map measurements.

20. The apparatus of claim 18, further comprising at least one of a transceiver or an antenna coupled to the at least one processor, wherein the at least one processor is further configured to:
transmit, for the at least one wireless device via at least one of the transceiver or the antenna, a request for the capability information, wherein to obtain the capability information, the at least one processor is configured to obtain the capability information based on the request.
